(19) United States
(12) Patent Application Publication
(10) Pub. No.: US 2014/0024008 A1
(43) Pub. Date: Jan. 23, 2014

(54) STANDARDS-BASED PERSONALIZED LEARNING ASSESSMENTS FOR SCHOOL AND HOME

(71) Applicant: Kumar R. Sathy, Durham, NC (US)

(72) Inventor: Kumar R. Sathy, Durham, NC (US)

(21) Appl. No.: 13/930,514

(22) Filed: Jun. 28, 2013

Related U.S. Application Data
(60) Provisional application No. 61/668,188, filed on Jul. 5, 2012.

(51) Int. Cl. G09B 7/00

(52) U.S. Cl. CPC G09B 7/00
USPC 434/362; 434/322

(57) ABSTRACT

Assessment devices, and teaching methods involving the use of the assessment devices, are disclosed. The assessment devices include iterative homework, quizzes, and/or tests, each of which allows for individual students to answer an initial question, and, based on the answer to that question, the next question will be harder or easier. The assessment devices can be administered to the students in print form, or electronically, such as on a computer or a personal digital assistant. Once the data is collated, students can be screened based on their ability to grasp all or a portion of the questions in a given test, and separated into groups based on their understanding of the subject matter. Teachers can then individually teach the different groups of students, ideally using lesson plans designed to work in tandem with the assessment devices, based on the students' grasp of the material.

### CROSS REFERENCE TO RELATED APPLICATIONS

This application claims priority to U.S. Provisional Application No. 61/668,188, filed on Jul. 5, 2012. The contents of U.S. Provisional Application No. 61/668,188 are hereby incorporated by reference for all purposes.

### FIELD OF THE INVENTION

The application is generally in the field of educational materials and software (“instructional aids”), and, more particularly, in the area of adaptive testing techniques. The instructional aids can be used to promote student learning and to facilitate compliance with national, state, or regional-specific educational standards.

### BACKGROUND OF THE INVENTION

There has been considerable effort geared at developing regional (e.g., local and national) educational standards to define knowledge and skills that students should possess at specified points (e.g., grades or ages) in their educational careers. Standardized tests intended to check whether students have demonstrated proficiency with regional educational standards are administered on a periodic (e.g., annual) basis. Grade-specific annual instructional programs are based on the assumption that students have gained proficiency with the educational standards for the prior grade and/or year.

Despite the importance of regional educational standards, there exists a lack of instructional materials and tests that fully address and incorporate such region-specific standards in a meaningful way. Textbooks are typically discipline-specific and are typically intended for use in numerous regions to maximize potential sales volume. Generic materials intended for audiences spanning regions with different educational standards may be difficult to adapt for use in a specific region to sufficiently focus on that region's educational standards. Teachers and school administrators often spend substantial resources trying to find or adapt materials to enable focused instruction of regional standards. Without identifying a correlation between content contained in an instructional aid and a specific educational standard, substantial effort is required to review and evaluate instructional aids to establish whether one or more portions of an instructional aid may be helpful in teaching concepts embodied in specific educational standards. Subject matter indices at the back of traditional textbooks may be of limited value in facilitating correlation between instructional aid content and educational standards, due to variations in specificity and terms used in textbook indices as compared to concepts embodied in region-specific educational standards.

The lack of correlation between instructional aids and region-specific educational standards increases the time teachers and school administrators spend adapting generic materials to region-specific requirements. Conventional instructional aids that have been adapted and used for teaching subsets of material embodied in region-specific educational standards are typically focused on a single academic discipline and typically embody non-fiction resources. Multiple instructional aids are typically required to satisfy the full complement of educational standards applicable to a particular region. The lack of integration between multiple instructional aids results in a suboptimal educational experience, as students are forced to switch frequently between different instructional aids, and may have difficulty maintaining engagement with each required contextual reorientation.

It would be desirable to provide instructional aids that help teach knowledge and skills embodied in a full range of regional educational standards, and to minimize the efforts of teachers and school administrators in evaluating generic instructional aids and adapting same to regional educational standards applicable to a specific school. It would further be desirable to provide instructional aids spanning multiple academic disciplines.

It is not only difficult to have teaching materials designed to cover a given regional curriculum, but it is also difficult to adapt these materials to teach students with different ability to grasp the materials. Students in today's classrooms require a varying degree of intervention and instruction in order to develop mastery of specific curriculum standards. Worksheets, assessments, and homework tend to offer a one-size-fits-all approach to instructional intervention by providing all students (regardless of current proficiency on a given standard) with the same series of problems to solve. A limitation of this is that students who misunderstand a concept and therefore make specific mistakes when solving related problems end up repeating the same mistakes on the instructional activity, thus reinforcing an inaccurate problem-solving method. In addition, a student who is only capable of solving the easiest types of problems for a given standard is presented with additional problems of varying complexity on the instructional activity, and therefore experiences the adverse consequences of failure, both during the activity and upon grading of the activity. Finally, such worksheets, assessments, and especially homework, do not provide opportunities for children needing enrichment or remediation to acquire such targeted personalized intervention.

One approach toward identifying students by their ability to solve problems is called adaptive testing. The approach generally involves successively providing students with questions selected to maximize the precision of the exam based on what is known about the student as determined by answers to previous questions. From the student's perspective, the difficulty of the exam seems to tailor itself to his or her level of ability. For example, when a student performs well on an item of intermediate difficulty, the next question is more difficult. If a student performs poorly, the next question is simpler. Compared to static multiple choice tests, with a fixed set of questions provided to all students, it has been argued that these computer-adaptive tests require fewer test items to arrive at equally accurate scores.

Typical computer-adaptive testing methods involve iterative algorithms. The algorithms provide a pool of available questions, which pool is searched for an optimal test question based on the current estimate of the student's ability. The student is presented with and answers a first question. Depending on whether the student answers the question correctly or incorrectly, the “ability estimate” is updated, and guides the selection of the next test question. The “ability estimate” is typically based upon all prior answers, rather than only the immediately preceding answer. These steps are repeated until a “termination criterion” is met (i.e., criteria for determining when to stop the test). The termination criterion can be based on time, number of questions, or other factors. Since the student's ability is not known before the examination is given, the algorithm generally starts by selecting a question of medium, or medium-easy, difficulty as the first question.

As a result of adaptive administration, different examinees receive quite different tests. The psychometric technology that allows equitable scores to be computed across different sets of items is known as item response theory (IRT). IRT has typically been viewed as the preferred methodology for selecting optimal items which are typically selected on the basis of information rather than difficulty, per se.

One advantage to adaptive tests is that they tend to provide uniformly precise scores for most test-takers, whereas standard fixed tests tend to provide the best precision for test-takers of medium ability, but poorer precision for test-takers with more extreme test scores, at both the high and low end. Another advantage is that these tests can be shorter in length than standard fixed tests, while still maintaining a higher level of precision. This results in less time to take a test, as students do not waste time attempting items that are too hard, or answering problems that are trivially easy.

The use of adaptive tests is also associated with certain disadvantages. One disadvantage is the need to calibrate the pool of questions. In order to determine whether questions are easy, of medium complexity, or hard, the questions are typically pre-administered to a sizable sample and then analyzed. One way to do this is to include the test questions into the operational questions of an exam, such that the responses to the test questions are recorded but do not contribute to the test-takers' scores (i.e., “pilot testing,” “pre-testing,” or “seeding”). This presents logistical, ethical, and security issues, and can be somewhat unfair if some students spend a disproportionate amount of time on test questions and not on actual questions, or answer a disproportionate number of test questions correctly, relative to actual questions.

Since adaptive tests administer easier items after a person answers incorrectly, an astute test-taker could potentially recognize, as the questions become easier, that they have made an incorrect answer and go back and change their answer. Another potential drawback is that the test taker could purposefully pick wrong answers, leading to an increasingly easier test, and, thus, a relatively higher number of correct answers.

It would be advantageous to provide an assessment that gauges an individual student's proficiency level at solving particular types of problems, particularly problems based on a regional or national standard, which does not require psychometric analysis. The present invention provides such an assessment.

### SUMMARY OF THE INVENTION

Assessment techniques, and assessment devices and evaluation tools for implementing the assessment techniques are disclosed. The assessment techniques are based on providing an iterative assessment tool, which can be, for example, a homework assignment, worksheet, quiz, or test, including pretests, summative assessments, and formative assessments, to students, where the students all start with the same question, and the next question is assigned based on the answer to the first question.

In one embodiment, the question is assigned by the activity, not the teacher.

The assessment devices can be in the form of homework, quizzes, or tests. A series of questions are prepared, and are broken down in terms of complexity into at least three groups—relatively easy, medium complexity, and relatively difficult. Typically, the first question that a student answers is a question of medium complexity. The student's ability to answer a question of medium complexity leads to the next question—if they answer correctly, the test questions get progressively harder, and if they answer incorrectly, the test questions get progressively easier, until the student demonstrates that he or she is ready for a harder question or in need of an easier question. In one embodiment, after one or more incorrect answers, a remedial lesson in the particular topic can be provided, along with or in advance of the subsequent question.

At their end, teachers can use a provided analysis to determine the student's mastery level, the type of questions the student ultimately answered, and struggles or excelled on, and the accommodation for intervention.

In all embodiments, the questions are multiple choice questions. However, the subject matter of the questions can vary depending on the intended purposes of the examination. For example, the assessment device is ideally intended to prepare students for national, regional, state, or local standardized tests, but can alternatively be used to teach students a more individualized curriculum.

The assessment device can be focused on teaching subjects of a particular gender, race, or other protected class, based on actual or perceived differences in how the different genders, races, and the like respond to different types of questions and/or teaching methods. However, it is preferable that all students are treated the same, regardless of gender or race, and without any preconceived notion about what students can or cannot learn about a particular type of subject matter. For example, in one embodiment, the questions are race and gender-neutral. In another embodiment, the questions can be geared toward students of a given race and/or gender.

In one embodiment, questions are prepared without using psychometric analysis, and in another embodiment, questions are prepared using psychometric analysis, though it is preferred not to use psychometric analysis when preparing the questions.

The assessment device can be administered in paper form, can be provided electronically on a computer or a network of computers, or can be administered via a personal digital assistant, such as a Blackberry®, I-phone®, Kindle, I-pad, digital page-turn devices, and the like.

In one embodiment, the assessment device is provided in the form of worksheets in paper form, which can make the assessment available to those students, and schools, with little or no access to electronic media.

Ideally, when the assessment devices are provided in paper form, the questions are provided in a machine-readable format that permits easy entry of the data into a computer, to permit rapid analysis of the data. However, the assessment devices can be provided in other than machine readable format, and a manual analysis of the answers can be performed.

When the assessment device is administered in computerized form, it can be part of a computerized testing device, which can optionally include a network editing interface to permit a teacher to generate customized homework, quizzes, and/or tests. Students can log onto the computerized testing device and do their homework, or take quizzes or tests, via a network, for example, using the internet, or at school, via a local area network (“LAN”). Ideally, the computerized testing device will include a network editing interface to provide teachers with teaching resources, and will also include a graphical user interface (GUI) to allow the teacher to create customized homework/quizzes/tests, and, optionally, associated customized teaching material.

When the testing device is computerized, and has a network editing interface, a teacher can generate customized assessment tools materials for students logging onto the computerized testing device to do their homework, or take quizzes or tests, via a network, such as the internet. The computerized testing device can include an examination managing module, a content database, a testing module and a recording module. A network editing interface can allow a teacher to generate multiple unique homework, quizzes, tests, and/or teaching materials, and can include and a network editing interface and one or more of a quiz database, a template database, and a teacher database.

When the testing (or “assessment”) is performed using a personal digital assistant, the students, each of which have access to a personal digital assistant, can log on remotely to do homework, or take a quiz or test stored on a database, and enter responses from their personal digital assistants. Each answer, and subsequent test question, is transmitted to and from the teacher's/school's database, the network, and the students' personal digital assistants. Student scores can be tallied and stored on the database, and accessed by the teacher.

In one embodiment, homework is assigned in a similar manner, and students are assigned a given number of homework problems. The teacher can then break the class into groups based on the students' perceived understanding of the subject matter in the homework assignment, and, after individualized training, test the students on the material. In this fashion, the students can be broken down into appropriate groups based on their grasp of the material before the lesson takes place.

In one embodiment, the student's scores for a given period of time can be tallied and reported, and used to show improvement over time, or lack thereof, as well as a measure of the student's overall ability with respect to specific subject matter.

The combination of iterative homework, “individualized teaching” based on groupings of students by their grasp of the subject matter, and adaptive testing, allow teachers to teach all of the students in the class, without focusing on the top or the bottom of the class. Where the tests are standardized tests, particularly those based on national, state, or regional standards, the teaching method can provide a way to optimize the students' ability to learn, by focusing primarily on those subjects where they are weakest, rather than those subjects in which they are the strongest.

Ideally, libraries of quiz, test and/or homework problems, teaching plans, and, optionally, software and hardware can be created to assist in implementing the assessment technique. Using these libraries, teachers can provide more personalized education, without having to spend a significant amount of out-of-class time preparing lesson plans for two, three, or more different levels of student performance.

The assessment can be both formative and summative, in that students can be assessed at the beginning of the school year, and throughout the school year, as well as at the beginning of a particular class, and throughout the class. Ideally, the assessment is formative in nature, not summative in nature, and is provided in-class, as homework, or both.

### BRIEF DESCRIPTION OF THE DRAWINGS

FIG. 1A is a schematic view of computer hardware and software system including an instructional device, adapted to implement methods as disclosed herein, and according to at least one embodiment of the present invention.

FIG. 1B is a schematic view of a communication system embodying multiple instructional devices and adapted to implement methods as disclosed herein, according to at least one embodiment of the present invention.

FIG. 2 is a schematic view of an instructional device display window including content and associated identifiers arranged as hyperlinks dispersed within content contained in the display window, with different identifiers corresponding to specific educational standards of at least one region, according to at least one embodiment of the present invention.

FIG. 3 is an excerpt from an instructional aid, including one viewable page or frame thereof, according to an embodiment of the present invention.

FIG. 4 is a template used to build an instructional aid. The excerpt is one viewable page of the template, that uses alphanumeric variables to indicate the difficulty level (H=Hard, M=Medium, E=Easy, BL=Baseline. The first number in the alphanumeric variables indicates the round number that the examinee is on (1=the first set of questions presented to the student after the baseline round). The second number in the alphanumeric variable indicates the question number within that round (1=the first question for that round and difficulty level). E21, for example, represents an easy question (E) present to the student in the second round of questioning (2) after the student has already answered a baseline question and a question from round one (most likely incorrectly, given the fact that he/she was directed to an easy question), and this part5icular question is the first in a series of easy questions (1). Each alphanumeric variable represents a unique corresponding question. The template aids the designer in creating appropriate questions with the correct difficulty level, as indicated by the corresponding framework (see FIG. 3).

FIG. 5 is a schematic view of a framework used to build an instructional aid, including question numbers, degree of difficulty per question, destinations, and degree of difficulty of said destinations. The excerpt is two viewable pages of the framework that uses alphanumeric variables to indicate the difficulty level. Correct answer choices are shaded, and the destinations point to alphanumeric variables that are associated with a question number, which can be determined by searching for the row that contains the corresponding level. For example, in framework 1, the answer choice “A” leads to destination E12. E12 is found in the final row of the table, and corresponds to question #26.

FIG. 6 is an excerpt from an instructional aid, including one viewable frame thereof, according to an embodiment of the present invention, which presents a specific educational standard of at least one region, including identification of at least one of four subjects (academic disciplines) with region-specific official identification numbers, and descriptions of concepts embodied in each specific educational standard.

FIG. 7 is an excerpt from an instructional aid, including one viewable frame thereof, according to an embodiment of the present invention, which presents a specific educational standard of at least one region, including identification of at least one of four subjects (academic disciplines), with region-specific official identification numbers, and descriptions of concepts embodied at each specific educational standard rewritten using simpler language that is free of educational jargon and tailored to parents, families, and/or students.

FIGS. 8 and 9 are examples of instructional aids, including an entire series of questions, with prompts to go from one question to another question based on the answer to a previous question, according to an embodiment of the present invention.

### DETAILED DESCRIPTION

Assessment devices, and teaching methods involving the use of the assessment devices, are disclosed. The assessment devices include homework, quizzes, and/or tests, each of which allows for individual students to answer an initial question, and, based on the answer to that question, the next question will be harder or easier.

In all embodiments, questions are multiple choice questions. The tests can proceed until a predetermined number of questions is answered, or a predetermined time has passed. Ideally, the questions are based on national, regional, or state standards for the given subject matter.

The assessment devices can be administered to the students in print form, or electronically, such as on a computer or a personal digital assistant.

The data is then collated, and students screened based on their ability to grasp all or a portion of the questions in a given test. That is, there may be more than one area being tested in a given test.

Based on the collated data, the students can be separated into two, three, or more groups of students, for example, those that understand the subject matter very well, those that have a median level of understanding of the subject matter, and those that have a poor grasp on the subject matter.

In one embodiment, data is collated by collecting paper copies of the tests and evaluating the answers, and in another embodiment, the students transmit the answers from their computers to a central location, either via e-mail, or by logging in remotely, ideally using a password, to a node that allows access to the test.

Optionally, teachers can then assign students automatically to two, three, or more different groups based on their ability to grasp the material, and optionally but preferably, provide a pre-determined set of teaching instructions based on the two, three, or more different groups of students, so that a teacher or group of two or more teachers can teach the students differently, based on their grasp of the material.

These elements are discussed in more detail below.

The following detailed description will be better understood with reference to the following definitions.

### Definitions

As used herein, the term “psychometric analysis” refers to the field of study concerned with the theory and technique of educational and psychological measurement, which includes the measurement of knowledge, abilities, attitudes, and personality traits. The field is primarily concerned with constructing and validating measurement instruments, such as questionnaires, tests, and personality assessments.

Psychometric analysis typically involves two major research tasks, namely: (i) the construction of instruments and procedures for measurement; and (ii) the development and refinement of theoretical approaches to measurement.

Psychometrics is applied widely in educational assessment to measure abilities in domains such as reading, writing, and mathematics. The main approaches in applying tests in these domains have been Classical Test Theory and the more recent Item Response Theory and Rasch measurement models. These approaches permit joint scaling of persons and assessment items, which provides a basis for mapping of developmental continua by allowing descriptions of the skills displayed at various points along a continuum.

### I. Computerized Adaptive Testing

While the assessment devices described herein can be computerized, they need not be. In those embodiments which are computerized, it is relevant to understand how computerized adaptive testing (“CAT”) can be used to assess students who have varying abilities to grasp the concepts being evaluated.

CAT successively selects questions so as to maximize the precision of the exam based on what is known about the examinee from previous questions. From the examinee's perspective, the difficulty of the exam seems to tailor itself to his or her level of ability. For example, if an examinee performs well on an item of intermediate difficulty, he will then be presented with a more difficult question. Or, if he performed poorly, he would be presented with a simpler question. Compared to static multiple choice tests that nearly everyone has experienced, with a fixed set of items administered to all examinees, computer-adaptive tests require fewer test items to arrive at equally accurate scores. In one embodiment, after one or more incorrect answers, a remedial lesson in the particular topic can be provided, along with or in advance of the subsequent question.

The basic computer-adaptive testing method is an iterative algorithm with the following steps:

1. The pool of available items is searched for the optimal item, based on the current estimate of the examinee's ability

2. The chosen item is presented to the examinee, who then answers it correctly or incorrectly

3. The ability estimate is updated, based upon all prior answers

4. Steps 1-3 are repeated until a termination criterion is met

The algorithm is generally started by selecting an item of medium, or medium-easy, difficulty as the first item.

As a result of adaptive administration, different examinees receive quite different tests. In one embodiment, psychometric technology known as item response theory (IRT) is used to allow equitable scores to be computed across different sets of items. IRT is also the preferred methodology for selecting optimal items which are typically selected on the basis of information rather than difficulty, per se.

Adaptive tests can provide uniformly precise scores for most test-takers, whereas standard fixed tests almost always provide the best precision for test-takers of medium ability and increasingly poorer precision for test-takers with more extreme test scores.

An adaptive test can typically be shortened by 50% and still maintain a higher level of precision than a fixed version. This translates into a time savings for the test-taker. Another advantage of using a computer-based test is that the results can be obtained almost immediately after testing.

In one embodiment, students are not allowed to review previous test questions (something which is difficult to enforce when the questions are administered in paper form).

CAT Components

There are five technical components in building a CAT:

1. Calibrated item pool

2. Starting point or entry level

3. Item selection algorithm

4. Scoring procedure

5. Termination criterion

Calibrated Item Pool

A pool of items must be available for the CAT to choose from. The pool can be calibrated, for example, with a psychometric model, such as item response theory.

Starting Point

In CAT, items are selected based on the examinee's performance up to a given point in the test. However, the CAT is obviously not able to make any specific estimate of examinee ability when no items have been administered. So some other initial estimate of examinee ability is necessary. If some previous information regarding the examinee is known, it can be used, but often the CAT just assumes that the examinee is of average ability. For this reason, the first item is often of medium difficulty.

Item Selection Algorithm

As mentioned previously, item response theory places examinees and items on the same metric. Therefore, if the CAT has an estimate of examinee ability, it is able to select an item that is most appropriate for that estimate. Technically, this is done by selecting the item with the greatest information at that point. Information is a function of the discrimination parameter of the item, as well as the conditional variance and pseudogues sing parameter (if used).

Scoring Procedure

After an item is administered, the CAT updates its estimate of the examinee's ability level. If the examinee answered the item correctly, the CAT will likely estimate their ability to be somewhat higher, and vice versa. This is done by using the item response function from item response theory to obtain a likelihood function of the examinee's ability. Two methods for this are called maximum likelihood estimation and Bayesian estimation. The latter assumes an a priori distribution of a student's ability, and has two commonly used estimators: expectation a posteriori and maximum a posteriori. Maximum likelihood is equivalent to a Bayes maximum a posterior estimate if a uniform (f(x)=1) prior is assumed.

Maximum likelihood is asymptotically unbiased, but cannot provide a theta estimate for a non-mixed (all correct or incorrect) response vector, in which case a Bayesian method may be used.

Termination Criterion

The CAT algorithm is designed to repeatedly administer items and update the estimate of examinee ability. This will continue until the item pool is exhausted, unless a termination criterion is incorporated into the CAT. For this reason, it can be advantageous to include a termination criterion, such as number of test questions or time allotted to take the test.

In one embodiment, the test is terminated when the student's standard error of measurement falls below a certain user-specified value. In this manner, examinee scores will be uniformly precise or “equiprecise.” Other termination criteria exist for different purposes of the test, such as if the test is designed only to determine if the examinee is should “Pass” or “Fail” the test, rather than obtaining a precise estimate of their ability.

Pass-Fail CAT

In many situations, the purpose of the test is to classify examinees into two or more mutually exclusive and exhaustive categories. This includes the common “mastery test” where the two classifications are “pass” and “fail,” but also includes situations where there are three or more classifications, such as “Insufficient,” “Basic,” and “Advanced” levels of knowledge or competency. The kind of “item-level adaptive” CAT is appropriate for gauging student's performance, providing good feedback to the students, and assigning the students to different groups depending on their relative mastery of the subject matter, so that they can be taught in a different manner depending on the group.

A different termination criterion and scoring algorithm cam be used if the test classifies the examinee into a category rather than providing a point estimate of ability. There are two primary methodologies available for this. The more prominent of the two is the sequential probability ratio test (SPRT). This formulates the examinee classification problem as a hypothesis test that the examinee's ability is equal to either some specified point above the cutscore or another specified point below the cutscore.

A confidence interval approach can also be used, where after each item is administered, the algorithm determines the probability that the examinee's true-score is above or below the passing score. For example, the algorithm may continue until the 95% confidence interval for the true score no longer contains the passing score. At that point, no further items are needed because the pass-fail decision is already 95% accurate, assuming that the psychometric models underlying the adaptive testing fit the examinee and test. This approach was originally called “adaptive mastery testing” but it can be applied to non-adaptive item selection and classification situations of two or more cutscores (the typical mastery test has a single cutscore).

As a practical matter, the algorithm is generally programmed to have a minimum and a maximum test length (or a minimum and maximum administration time).

The item selection algorithm used depends on the termination criterion. Maximizing information at the cutscore is more appropriate for the SPRT because it maximizes the difference in the probabilities used in the likelihood ratio. Maximizing information at the ability estimate is more appropriate for the confidence interval approach because it minimizes the conditional standard error of measurement, which decreases the width of the confidence interval needed to make a classification.

### II. Assessment Devices

The assessment devices are based on providing an iterative assessment tool to students, where the students all start with the same question, and the next question is assigned based on the answer to the first question. The assessment tool can be, for example, a homework assignment, quiz, or test, including a formative assessment, summative assessment, or pretest, with formative assessments being particularly preferred from the standpoint of initially teaching the material.

A series of questions are prepared, and are broken down in terms of complexity into at least three groups—relatively easy, medium complexity, and relatively difficult. Typically, the first question that a student answers is a question of medium complexity. The student's ability to answer a question of medium complexity leads to the next question—if they answer correctly, the test questions get progressively harder, and if they answer incorrectly, the test questions get progressively easier. However, once the student answers a question correctly, the next question will be harder, and vice versa.

In all embodiments, the questions are multiple choice questions. However, the subject matter of the questions can vary depending on the intended purposes of the examination. For example, the examination is ideally intended to prepare students for national, regional, state, or local standardized tests, but can alternatively be used to teach students a more individualized curriculum.

The questions can encompass a plurality of academic disciplines. That is, the questions can cover teachable concepts directed to more than one academic discipline (or “subject”) as referenced in a region-specific educational standard. The term “encompasses” contemplates more than token reference or passing reference to a second or subsequent academic discipline. In various embodiments, content included in the instructional aid encompasses at least two, preferably at least three, and still more preferably at least four of the following academic disciplines (i) to (iv): (i) science; (ii) mathematics; (iii) social studies; and (iv) any of English, language arts, reading, and writing.

In one embodiment, the assessment device, whether in the form of a homework assignment, quiz or test, can be divided into multiple parts, with at least some parts including content including at least two, more preferably at least three, and more preferably at least four of the foregoing academic disciplines. In one embodiment, an instructional aid embodies a plurality of pages or windows, with at least some pages or windows including content including at least two, more preferably at least three, and more preferably at least four of the foregoing academic disciplines.

The assessment device can be focused on teaching subjects of a particular gender, race, or other protected class, based on actual or perceived differences in how the different genders, races, and the like respond to different types of questions and/or teaching methods. However, it is preferable that all students are treated the same, regardless of gender or race, and without any preconceived notion about what students can or cannot learn about a particular type of subject matter. For example, in one embodiment, the questions are race and gender-neutral. In another embodiment, the questions can be geared toward students of a given race and/or gender.

In one embodiment, questions are prepared without using psychometric analysis, and in another embodiment, questions are prepared using psychometric analysis, though it is preferred not to use psychometric analysis when preparing the questions.

The assessment devices can include a viewable index correlating the plurality of identifiers to state, national, or regional educational standards. The term “viewable index” as used herein refers to an index that may be presented in whole or in part to a user or viewer in any suitable permanent or non-permanent format, including, for example, in print form on a printed document or volume, or in display form on a suitable display device such as a monitor or display screen. At least a portion of such index may be viewable at any one time.

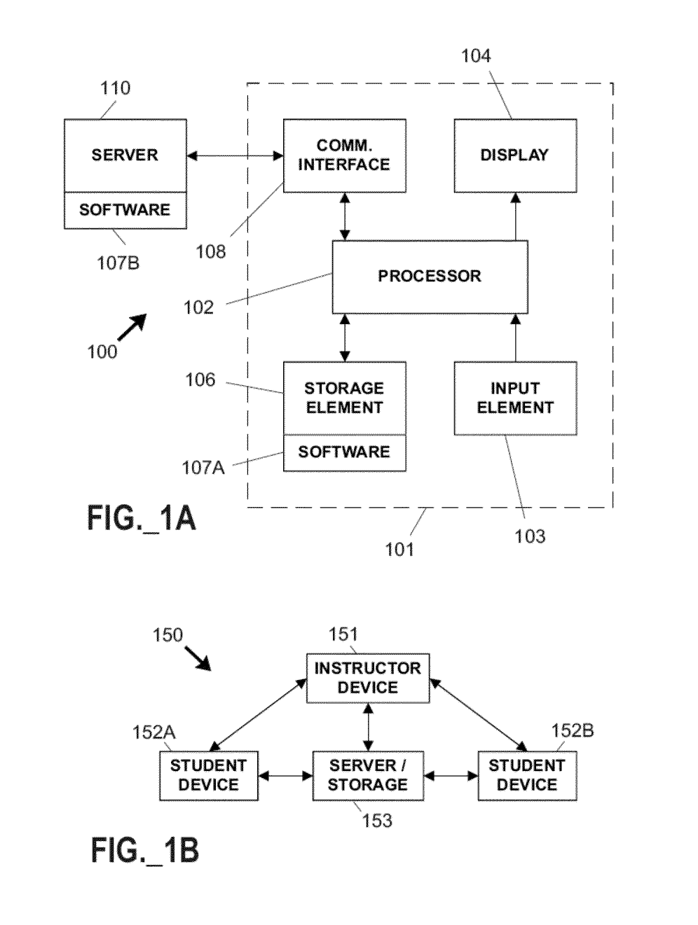

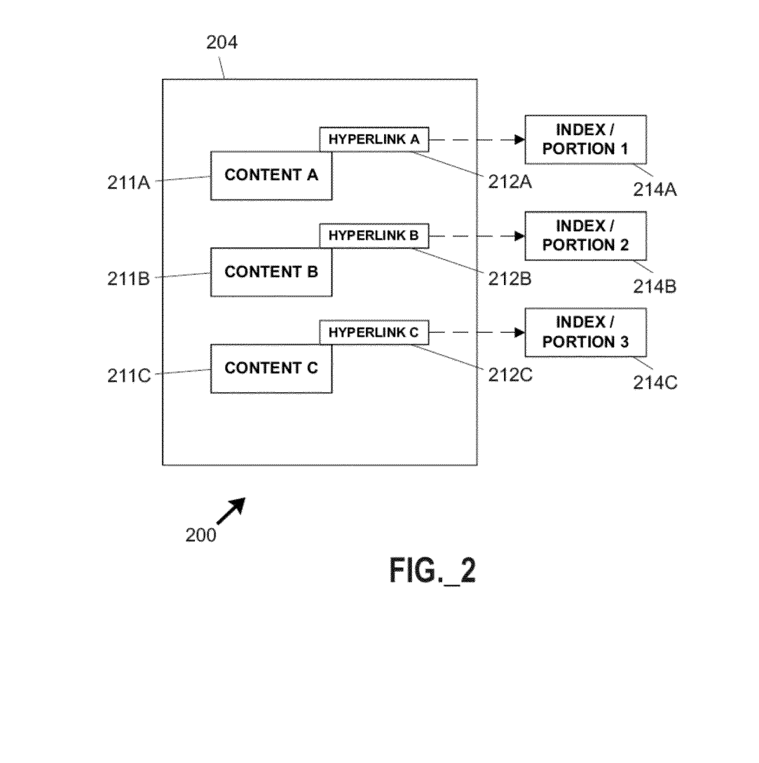

Identifiers corresponding to specific educational standards may be of any suitable user-perceptible type. In various embodiments, identifiers may include different alphanumeric symbols, symbolic elements, shapes, and/or colors in various combinations. One example of an index according to one embodiment is illustrated in FIG. 1, where a grey color coded section of the assessment device includes a state identifier, as well as an identifier for the particular state standard being evaluated.

Identifiers can, for example, be arranged and/or presented by identifier reference number, subject, regional educational standard identification, description of standard or course concept, and included use.

The assessment device can also be labeled as covering various academic subjects or disciplines, for example, (i) English/Language Arts, (ii) Mathematics, (iii) Science, and (iv) Social Studies). For example, identifiers can be provided in assessment device to embody one or more letters (i.e., “E,” “M,” “S,” or “SS”) combined with one or more numbers. The academic discipline or subject embodied can be represented in word form (i.e., English, Math, Science, or Social Studies). The regional educational standards can be represented by numerical code. The description of standard or course concept preferably includes a description of the entire standard, or at least a descriptive abbreviation thereof, to permit the user to understand the nature and purpose of each educational standard. The assessment device can includes a box for check marks to demonstrate inclusion of content relating to each regional educational standard in the instructional aid. In an alternative embodiment, the assessment device may include page, chapter, and/or section numbers corresponding to inclusion of content corresponding to each educational standard, and where information on the types of questions can be found in the students' written materials/instructional aids/textbooks.

Identifiers may be dispersed within the assessment device, with identifiers correlated to academic standards of one or more regions preferably being linked to specific test questions (i.e., on a question-specific basis). In other embodiments, identifiers may be linked on a homework/test/quiz basis and/or page-specific basis within homework, tests, or quizzes.

A single assessment device may therefore include questions embodying and correlated to multiple educational standards of one or more regions.

The assessment devices can be customized, for example, by providing the teacher with a pre-organized series of questions of varying levels of complexity, which correspond to the standard or other such subject matter being tested. The teacher can select the various questions based on their level of complexity, and the grid of questions in the assessment device. For example, the assessment device can include, rather than questions, a grid showing that if the student answers a given question correctly, the next question should be from a specific group, and if the student answers the question incorrectly, the next question should be from a different group.

When teachers prepare multiple choice questions, they tend to consider how a student might come up with a wrong answer, and include the wrong answer as one of the choices. If a student answers a question incorrectly, and the teacher has a sense of how the student came up with the wrong answer, this information can inform the teacher as to how best to select the next question.

When the students answer the multiple choice questions correctly, the next question is typically more difficult. However, though there is only one correct answer, there can be several incorrect answers, and depending on the incorrect answer to the question, the teacher can guide the student appropriately using the next question. The questions can be selected from pre-arranged libraries of questions, to facilitate development of a custom assessment device, if the teacher, or the school administration, is not in favor of having a teacher use entirely pre-prepared assessment devices.

In one embodiment, when repeated errors are made, the student may be directed to a mini-lesson, rather than immediately to another question, to reinforce the proper way to answer the questions, and then asked to proceed to another question to determine whether the student was able to learn from the mini-lesson how to properly answer a similar question.

As described in more detail below, the assessment devices can be administered in paper form, can be provided electronically on a computer or a network of computers, or can be administered via a personal digital assistant, such as a Blackberry®, I-phone®, Kindle®, I-Pad™, and the like.

Assessment Devices Provided in Paper Form

The assessment devices described herein can be in the form of a non-electronic print medium. Examples of non-electronic print media include, but are not limited to, literary works, books, printed volumes, pamphlets, and printed transparencies adapted to permit projected display.

Ideally, when the assessment devices are provided in paper form, the questions are provided in a machine-readable format that permits easy entry of the data into a computer, to permit rapid analysis of the data. However, the assessment devices can be provided in other than machine readable format, and a manual analysis of the answers can be performed.

Assessment Devices Provided in Computerized Form

In another embodiment, the assessment device can be provided in an electronic medium, including electronic print media. An assessment device can be embodied at least in part in a computer-readable instruction set, such as software, which can be saved to a memory element. Such instruction set or software can operate in conjunction with a microprocessor-based computing device having an associated input element and an associated display element arranged to display content and/or at least a portion of an index of identifiers correlated to academic standards for at least one region.

Examples of suitable computing devices include desktop computers, laptop computers, multimedia/game consoles, personal digital assistants, portable telephones, electronic presentation boards, and wireless electronic reading devices (e.g., Kindle™ Amazon.com, Seattle, Wash.), Nook™ (Borders) or I-Pad (Apple). Such computing device may include an instruction set or software in memory internal to the device or in a removable memory element, or at least a portion of the instruction set or software may be stored in a memory located remotely from the computing device, with the instruction set or software being accessible via a communication network (e.g., internet, wired telephone network, wireless telephone network, WiFi, or WiMax). A microprocessor-based computer hardware and software system may incorporate an assessment device as described herein. A microprocessor-based hardware device can be used to access, via a network, an assessment device that is remotely stored on a server or other accessible memory element.

When the assessment devices are administered in computerized form, they can be part of a computerized testing device, which can optionally include a network editing interface to permit a teacher to generate customized homework, quizzes, and/or tests. Students can log onto the computerized testing device and take assessment tools via a network, for example, using the internet, or at school, via a local area network (“LAN”). Ideally, the computerized testing device will include a network editing interface to provide teachers with teaching resources, and will also include a graphical user interface (GUI) to allow the teacher to create customized homework/quizzes/tests, and, optionally, associated customized teaching material.

When the testing (or “assessment”) is performed using a personal digital assistant, the students, each of which have access to a personal digital assistant, can log on remotely to do homework, or take a quiz or test, which is stored on a database, and enter responses from their personal digital assistants. Each answer, and subsequent test question, is transmitted to and from the teacher's/school's database, the network, and the students' personal digital assistants. Student scores can be tallied and stored on the database, and accessed by the teacher.

### II. Relative Arrangements of Computer Hardware and Software Components

When students take the tests over a computer network, whether over the internet or on a LAN, there needs to be some way to manage the flow of data. One way to provide for relative arrangements of computer hardware and software components of an assessment device and/or a system comprising an assessment device is shown in FIG. 1.

A system 100 includes an electronic media assessment device 101 that preferably includes a processor 102, a user input element 103, a display element 104, and a storage element 106 optionally including software 107A or a computer-readable instruction set embodying content and identifiers as disclosed herein. The assessment device 104 preferably includes a communication interface 108 (e.g., for wired and/or wireless communication of any suitable type, whether to a single specified other device or a network that may include other user interfaces). The communication interface 108 may be arranged to communicate with an external host or server 110 (or an external communication device), with the external device 110 optionally being arranged to run software 107B or a machine-readable instruction set embodying content and identifiers, and desirably including an index correlating identifiers to region-specific educational standards, as disclosed herein. Communications between the communication interface 108 and the external host or server 110 can be facilitated by a wired or wireless link, and is preferably implemented via a local or distributed computer or telecommunications network (e.g., an intranet or the Internet, and/or a telephone or other data network).

In one embodiment, multiple electronic media devices 151, 152A, 153B may be arranged to communicate with one another, whether directly or through one or more intermediary server and/or storage elements 153. The resulting communication system 150 can enable dissemination of content (e.g., software, modules, updates, and/or customized assessment devices or additional content added by an instructor) from an electronic instructor device 151 to one or more electronic student devices 152A-152B. An associated server and/or storage element 153 may track usage of student devices 152A, 152B and make such usage information available to the instructor device 151.

Although in most embodiments, students taking quizzes or tests should work alone, it is frequently helpful for students to work together on projects, such as homework problems. Student devices 152A-152B can be allowed to communicate with one another, whether directly or through an intermediary device 151 or 153 to regulate timing and flow of content, such as to enable multiple students to discuss content, and/or collaborate or otherwise work together on projects or assessment devices relating to the content.

In an assessment comprising an electronic medium according to one embodiment, identifiers corresponding to region-specific educational standards can be embodied in hyperlinks, allowing display of an index of identifiers or a portion thereof. As shown in FIG. 7, a display window 204 of an assessment device 200 can include various items of content, including content items 211A-211C each having at least one associated identifier (corresponding to a region-specific educational standard) in the form of a hyperlink 212A-212C. User selection of each hyperlink 212A-212C (e.g., with an input device) may enable retrieval and/or display of (i) an index correlating identifiers to educational standards of at least one region, and/or (ii) portions 214A-214C of such an index. Each hyperlink may be adapted to permit viewing of the viewable index and/or to a textual identification of an educational standard corresponding to the identifier.

User entries can be stored in a memory element arranged local to or remote from an instructional device used by a student, to enable tracking of student usage and responses. In one embodiment, student usage information may be transmitted to a data repository and/or reporting module to enable usage and/or proficiency tracking on the basis (or bases) of specific students, classrooms, schools, school districts, states, and/or other regions.

Network Editing Interface

When the testing device is computerized, and has a network editing interface, a teacher can generate customized assessment devices for students logging onto the computerized testing device to do their homework, or take quizzes or tests, via a network, such as the internet. The computerized testing device can include an examination managing module, a content database, a testing module and a recording module. A network editing interface can allow a teacher to generate multiple unique homework, quizzes, tests, and/or teaching materials, and can include and a network editing interface and one or more of a quiz database, a template database, and a teacher database.

Collection and Evaluation of the Data

The assessment devices described herein allow teachers to assess their students on a more frequent basis than just at test time. That is, homework problems can be given to the students, and if each student's ability to solve the homework problems is evaluated before the next day's lesson begins, the students can be broken up into groups, and customized lesson plans can be provided to each group depending on their grasp of the evaluated material.

A given student's performance may vary from one set of homework problems associated with a regional standard to another set of homework problems. By collating data, and grouping students on a relatively frequent basis, students can receive a more customized education, where the lesson plans are different depending on whether they have a strong grasp, modest grasp, or little or no grasp, of the subject matter being assessed. In this manner, students who normally excel at all subjects, but who miss a particular subject, can be identified, and students who normally do not excel at subjects, but who excel at a particular subject, can be identified as well. In this manner, the separate groups of students (i.e., those who have a strong grasp, modest grasp, or little or no grasp, of the subject matter being assessed) will not necessarily always include the same students, but they will include students whose performance on an assessment (homework, quiz, or test) indicates that they belong in a particular group, on a particular date, for a particular lesson, in connection with a particular standard.

In lieu of, or in addition to, homework assignments, students can be given periodic quizzes, and based on the results of the quizzes, the students can similarly be broken up into separate groups for a more individualized lesson covering the subject matter, the understanding of which was assessed using the quiz.

In one embodiment, the student's scores for a given period of time can be tallied and reported, and used to show improvement over time, or lack thereof, as well as a measure of the student's overall ability with respect to the given subject matter. That is, the assessment of each student can be both formative and summative, in that students can be assessed at the beginning of the school year, and throughout the school year, as well as at the beginning of a particular class, and throughout the class.

Ideally, the assessment is formative in nature, not summative in nature, and is provided either in-class, or as homework.

### IV. Customized Lesson Plans

It is hard enough for a teacher to develop one lesson plan to cover all of his/her students, and even harder to develop a series of lesson plans to cover students with different abilities to grasp the subject matter being tested. For this reason, in addition to providing homework, quizzes, and/or tests that can be used to evaluate the students, the assessment devices described herein can be paired with appropriate lesson plans, which can be used to teach the different groups of students.

In use, the teacher can evaluate the students' performance on the homework, quiz, and/or test, and then break the students into separate groups. Pre-packaged lesson plans geared to a) the standard or other such material tested, and b) the separate groups of students, can be used to provide a more customized approach to teaching the different groups of students, without requiring a teacher to develop three separate lesson plans for each subject that is taught.

This approach is ideally suited for teaching national, state, or regional standard, in that the teaching methods, assessment devices, and the like can be relatively homogeneous from school to school, thus providing a pathway for all students in a given school district, state, region, and the like, to receive a comparable education covering comparable material.

Packages of Educational Materials

The combination of iterative homework, “individualized testing” based on groupings of students by their grasp of the subject matter, and adaptive testing, as well as individualized lesson plans, allows teachers to teach all of the students in the class, without focusing on the top or the bottom of the class. Where the tests are standardized tests, particularly those based on national, state, or regional standards, the teaching method can provide a way to optimize the students' ability to learn, by focusing primarily on those subjects where they are weakest, rather than those subjects in which they are the strongest.

Ideally, the existence of libraries of test and/or homework problems, teaching plans, and, optionally, software and hardware to assist in implementing the assessment technique, the teachers can provide more personalized education, without having to spend a significant amount of out-of-class time preparing lesson plans for two, three, or more different levels of student performance.

The present invention will be better described with reference to the following non-limiting examples.

### EXAMPLE 1

### Representative Standards-Based Test

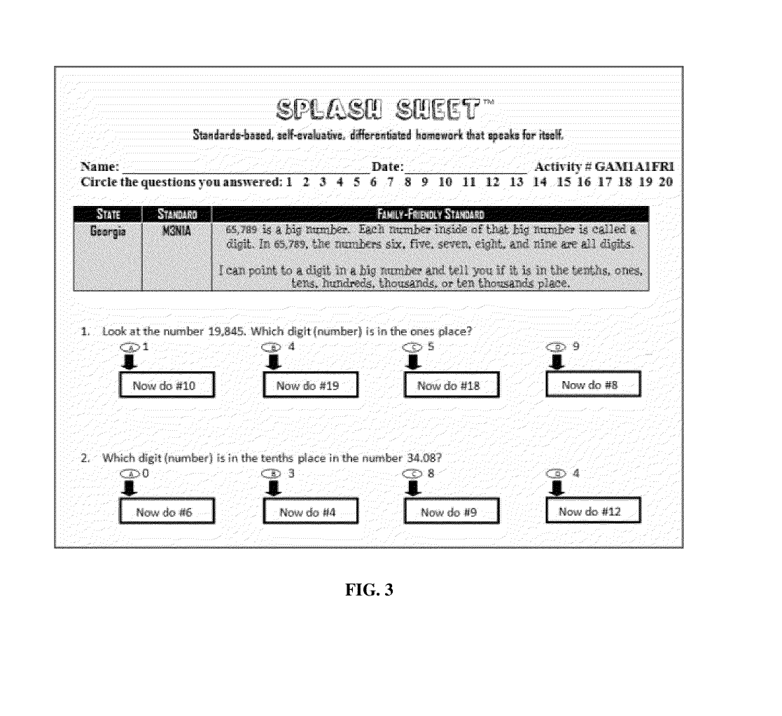

A representative instructional aid is shown in FIG. 3, which is a homework sheet showing the state, the particular standard within the state, and a series of questions. The sheet also includes a series of answers to the questions, and directions regarding the next question to take, based on the answer to the question.

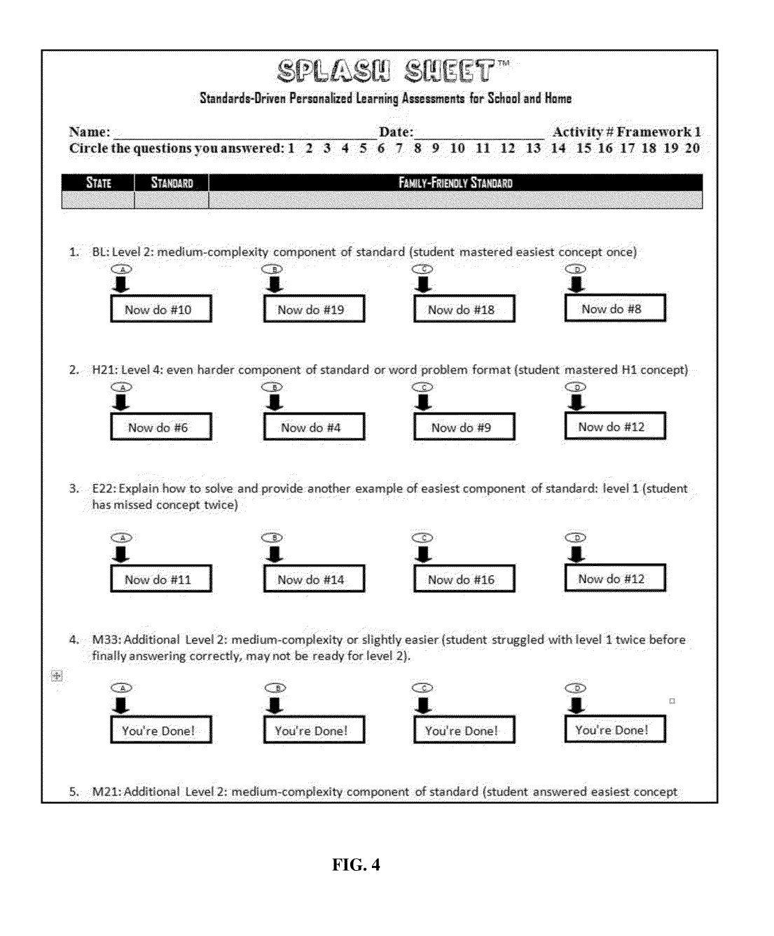

FIG. 4 is a template used to build an instructional aid. The excerpt is one viewable page of the template, that uses alphanumeric variables to indicate the difficulty level (H=Hard, M=Medium, E=Easy, BL=Baseline. The first number in the alphanumeric variables indicates the round number that the examinee is on (1=the first set of questions presented to the student after the baseline round). The second number in the alphanumeric variable indicates the question number within that round (1=the first question for that round and difficulty level). E21, for example, represents an easy question (E) present to the student in the second round of questioning (2) after the student has already answered a baseline question and a question from round one (most likely incorrectly, given the fact that he/she was directed to an easy question), and this part5icular question is the first in a series of easy questions (1). Each alphanumeric variable represents a unique corresponding question. The template aids the designer in creating appropriate questions with the correct difficulty level, as indicated by the corresponding framework (see FIG. 3).

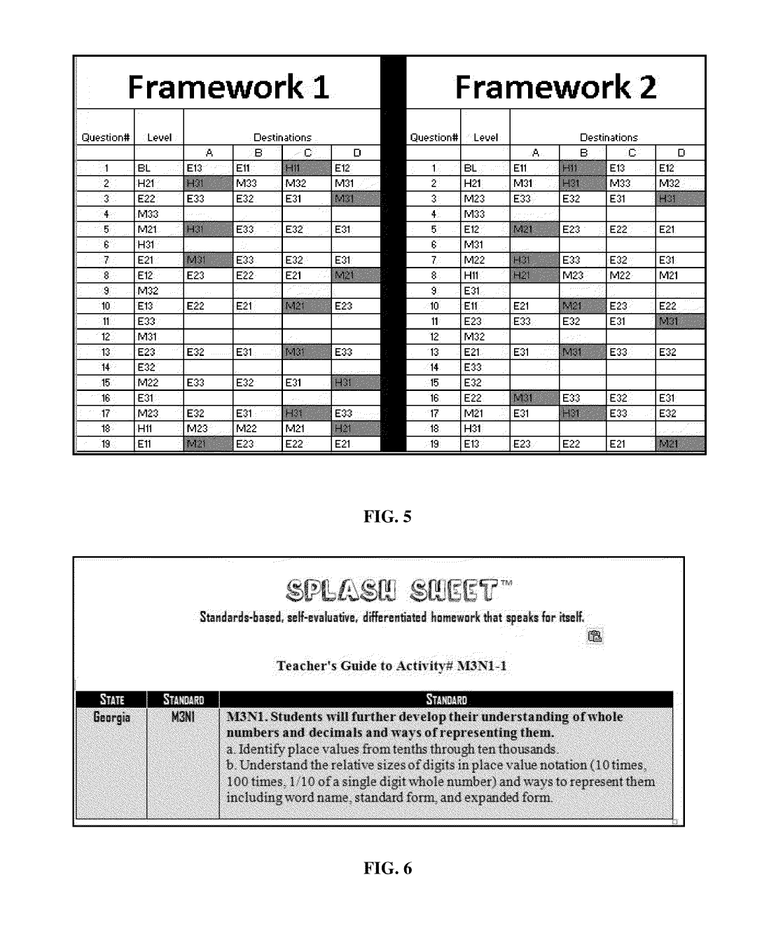

FIG. 5 is a schematic view of a framework used to build an instructional aid, including question numbers, degree of difficulty per question, destinations, and degree of difficulty of said destinations. The excerpt is two viewable pages of the framework that uses alphanumeric variables to indicate the difficulty level. Correct answer choices are shaded, and the destinations point to alphanumeric variables that are associated with a question number, which can be determined by searching for the row that contains the corresponding level. For example, in framework 1, the answer choice “A” leads to destination E12. E12 is found in the final row of the table, and corresponds to question #26.

Using this framework, a teacher can design customized homework, quizzes, and/or tests.

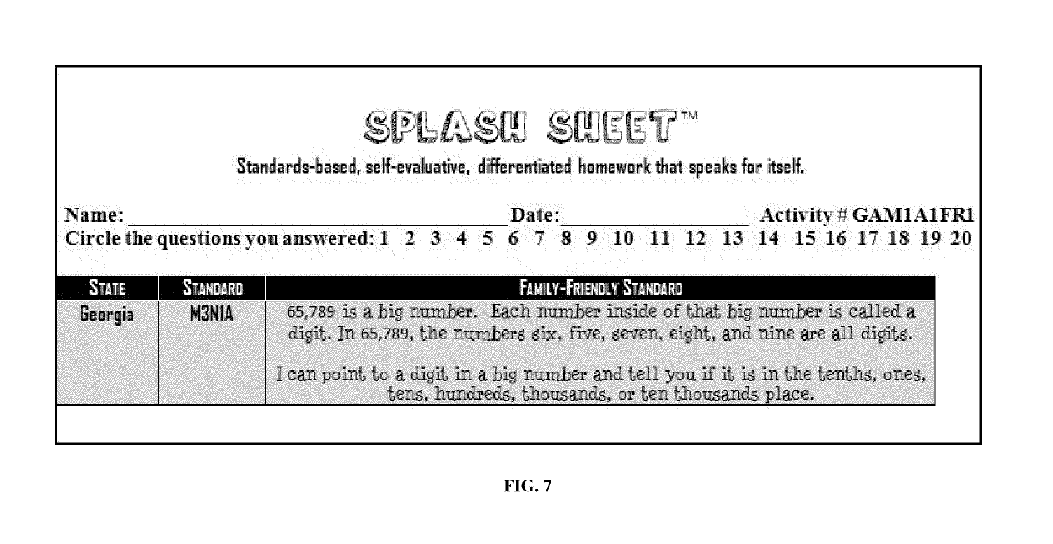

FIG. 6 is an excerpt from an instructional aid, including one viewable frame thereof, according to an embodiment of the present invention, which presents a specific educational standard of at least one region, including identification of at least one of four subjects (academic disciplines) with region-specific official identification numbers, and descriptions of concepts embodied in each specific educational standard.

FIG. 7 is an excerpt from an instructional aid, including one viewable frame thereof, according to an embodiment of the present invention, which presents a specific educational standard of at least one region, including identification of at least one of four subjects (academic disciplines), with region-specific official identification numbers, and descriptions of concepts embodied at each specific educational standard rewritten using simpler language that is free of educational jargon and tailored to parents, families, and/or students.

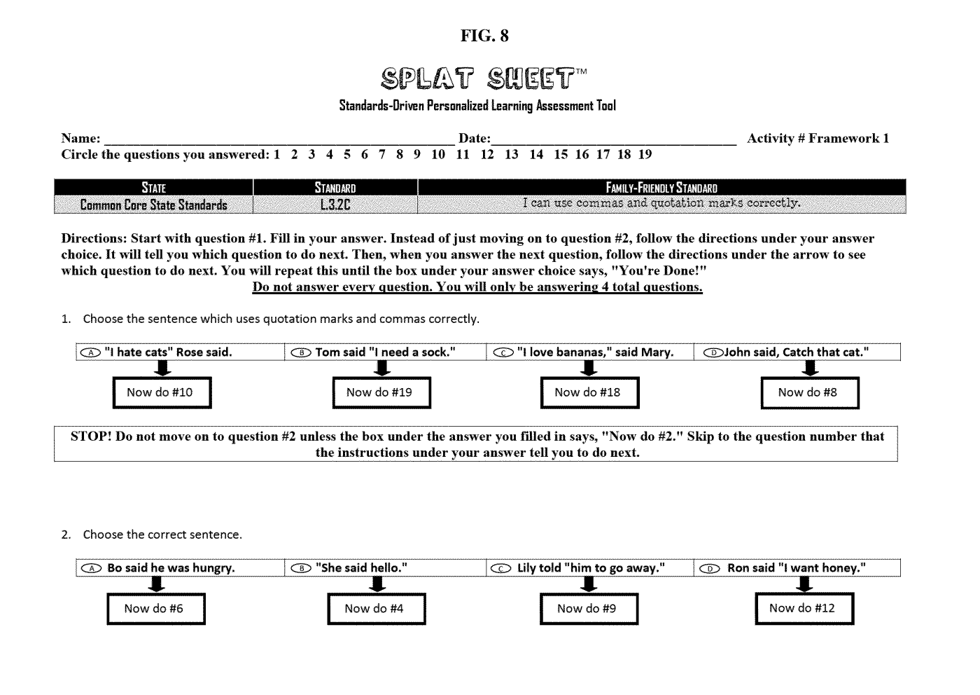

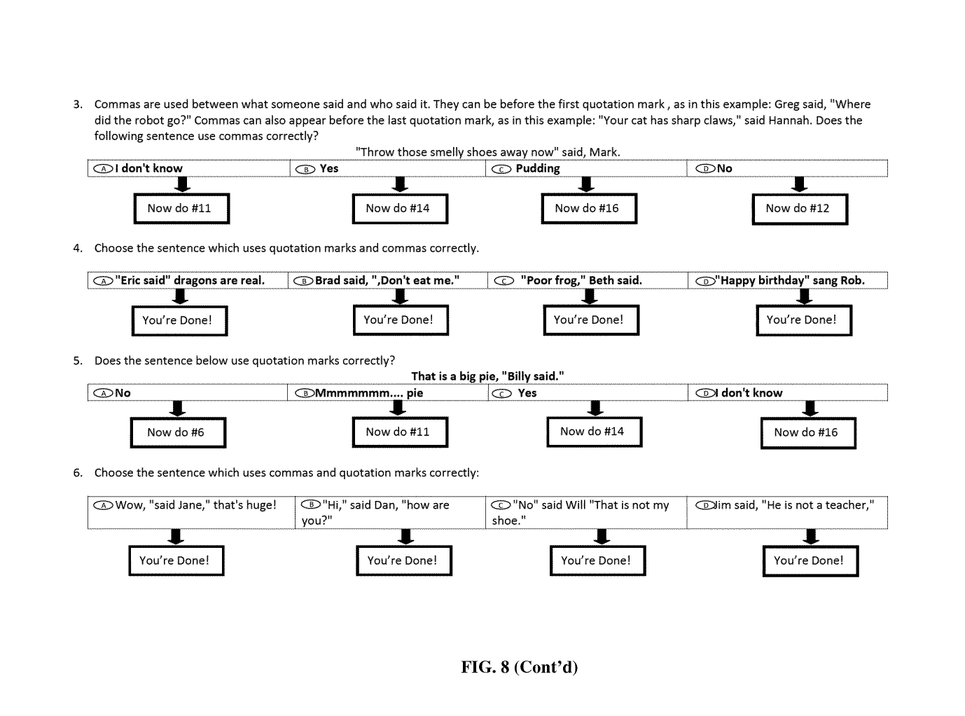

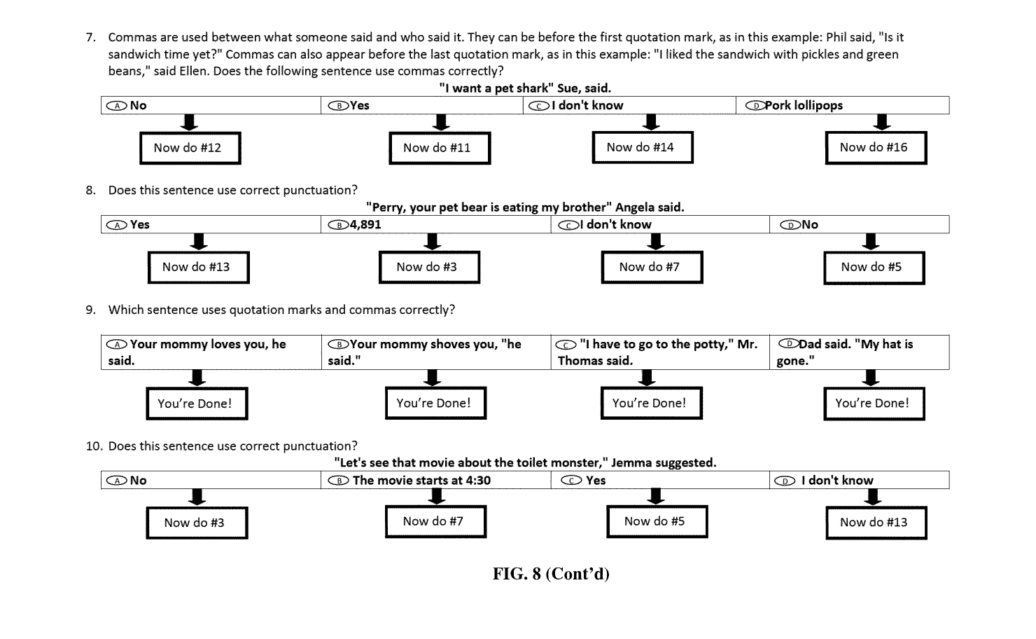

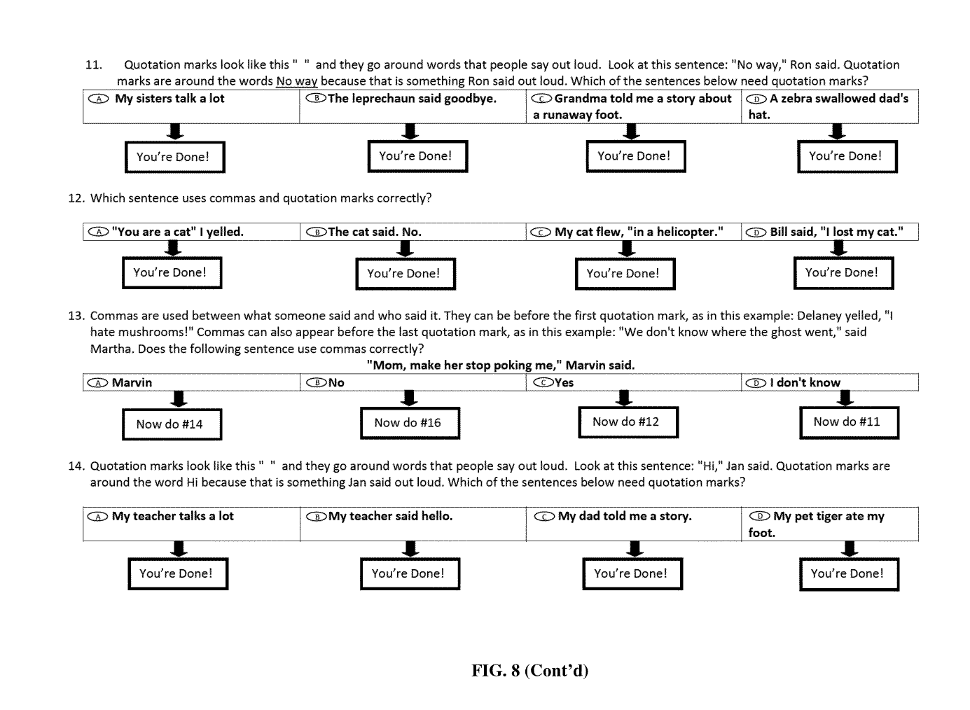

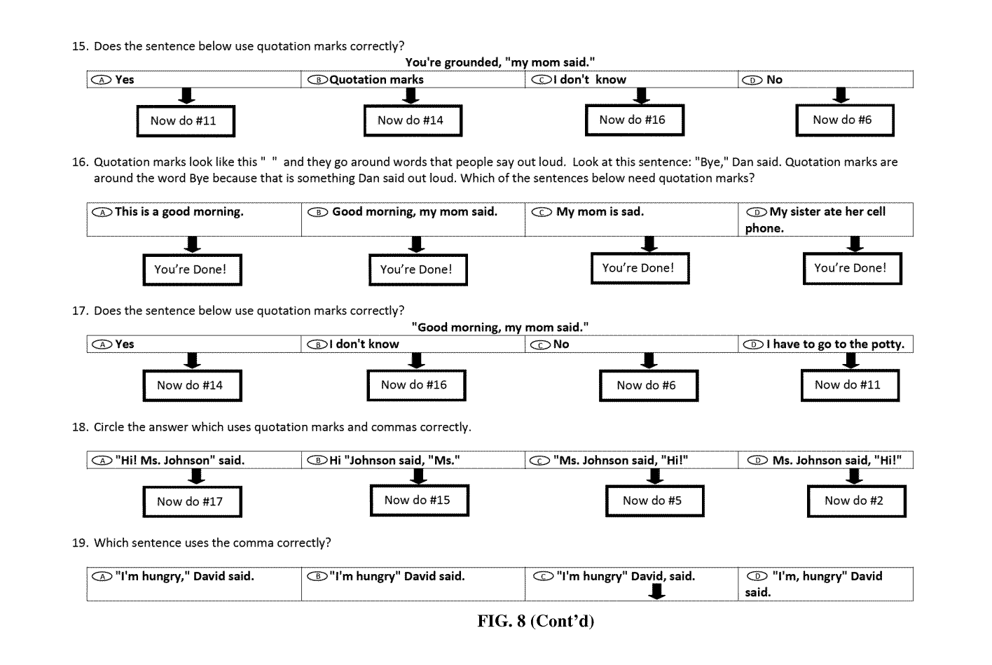

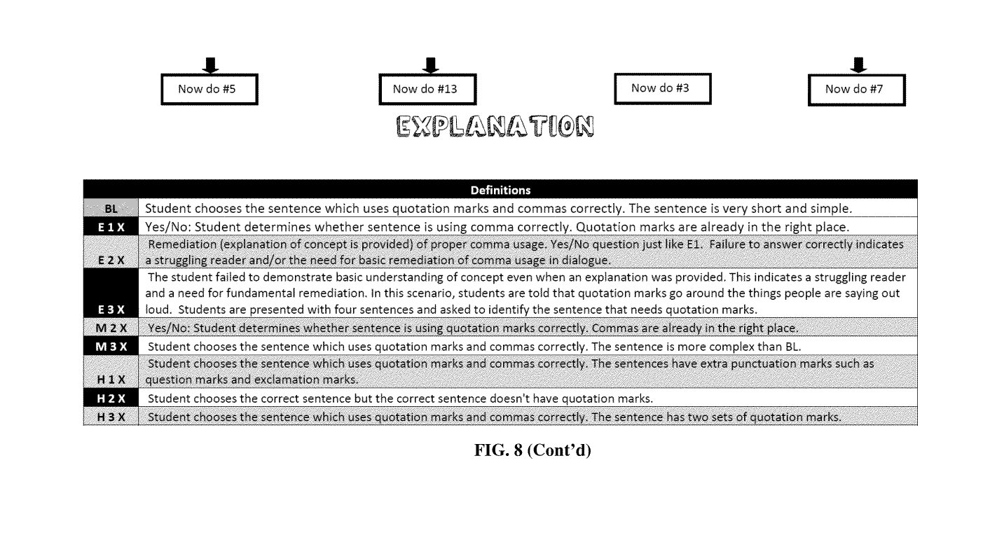

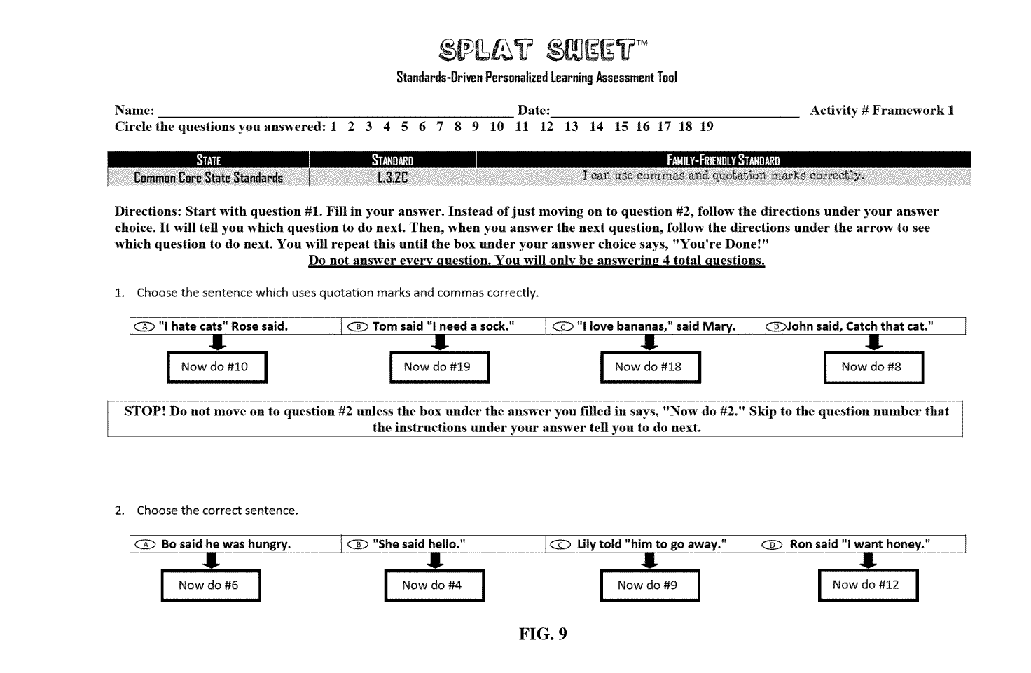

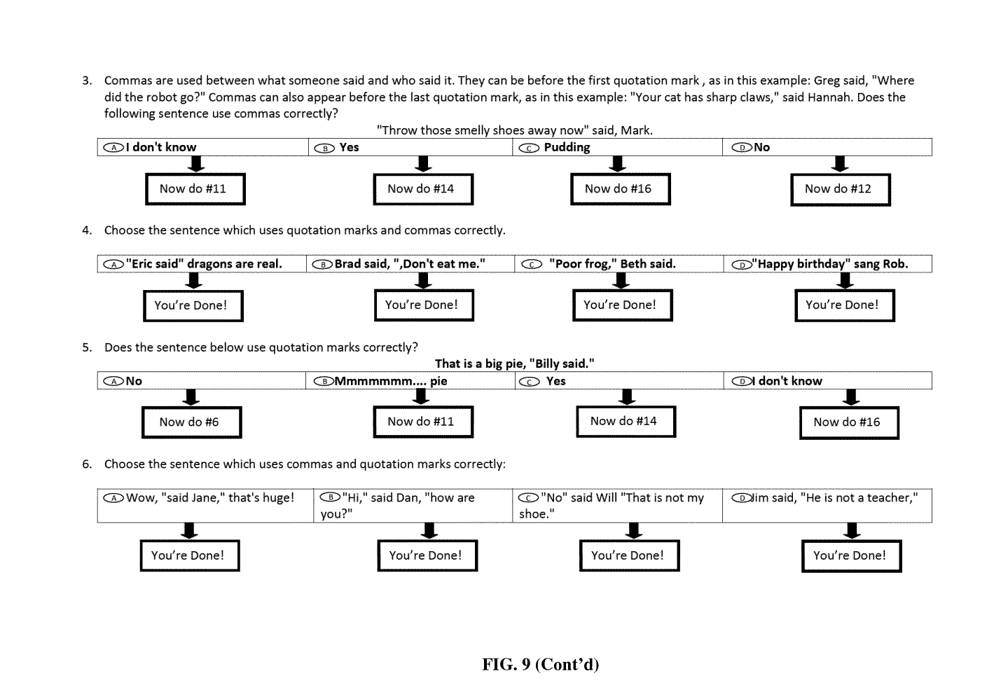

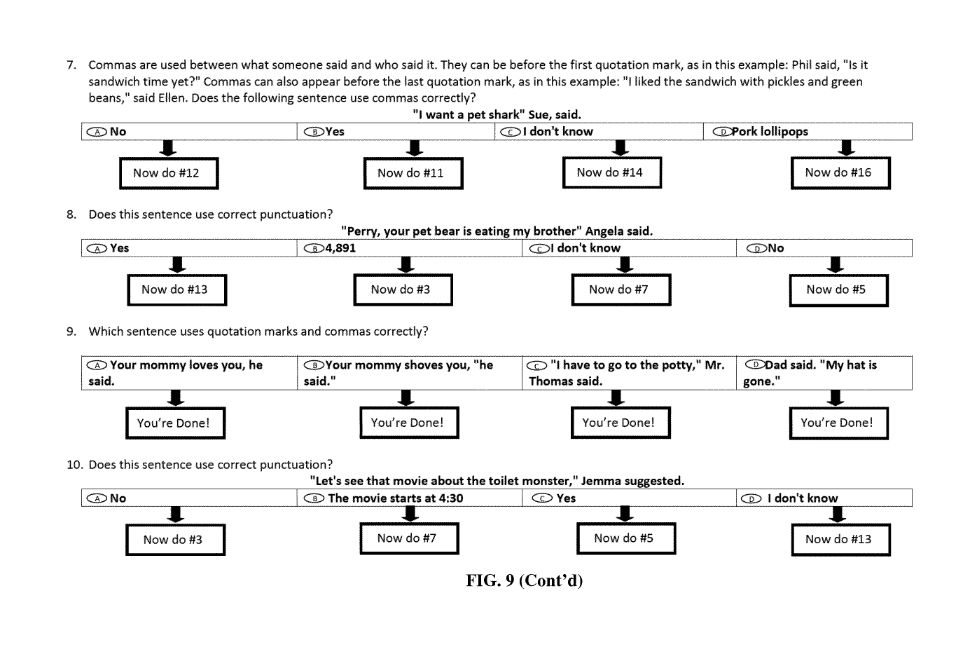

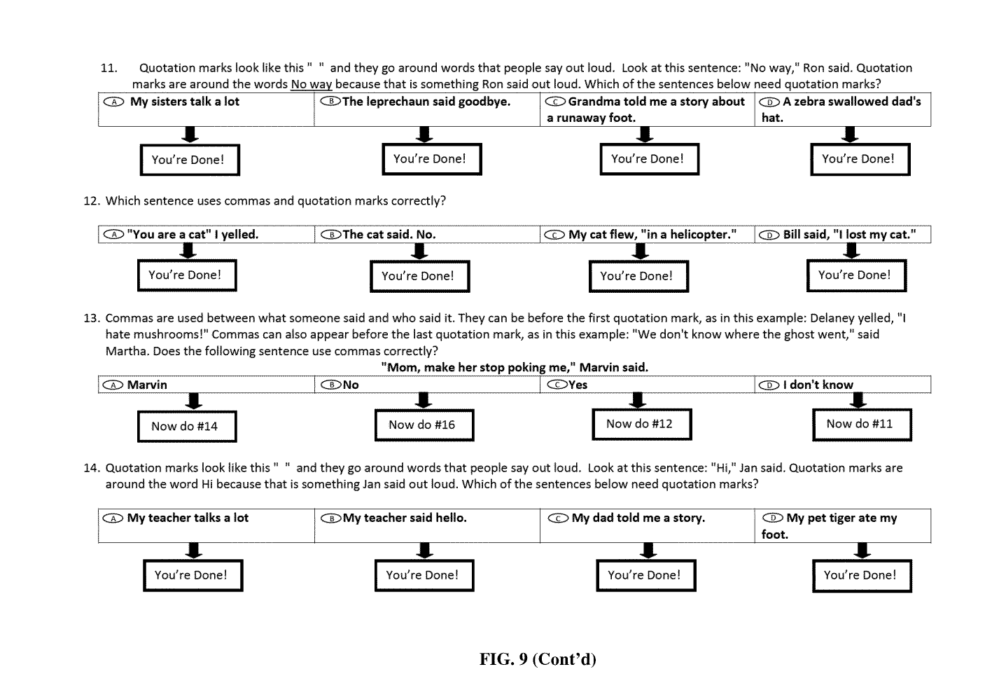

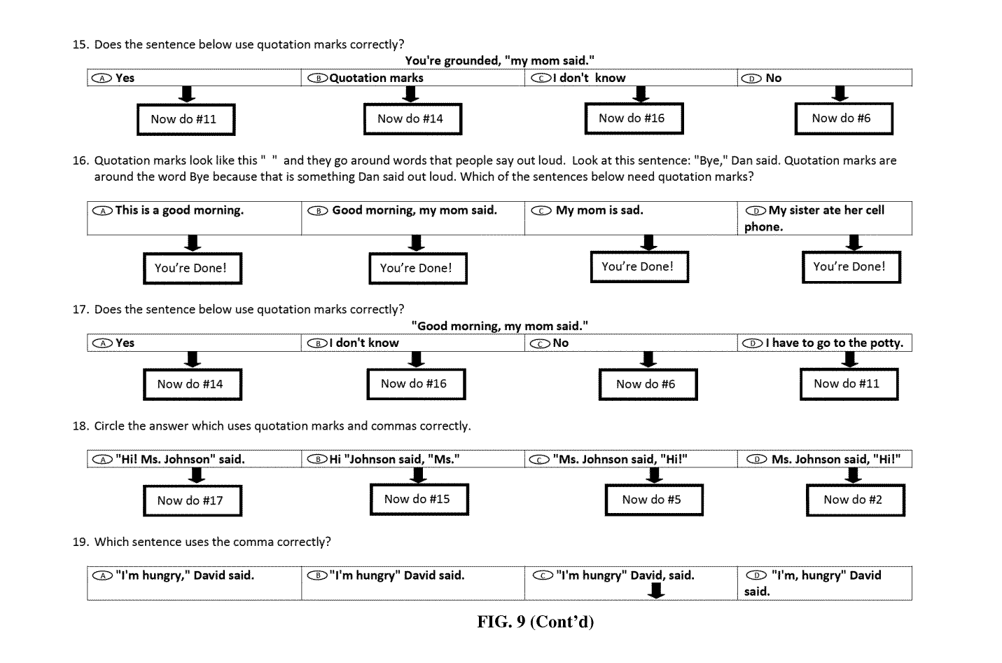

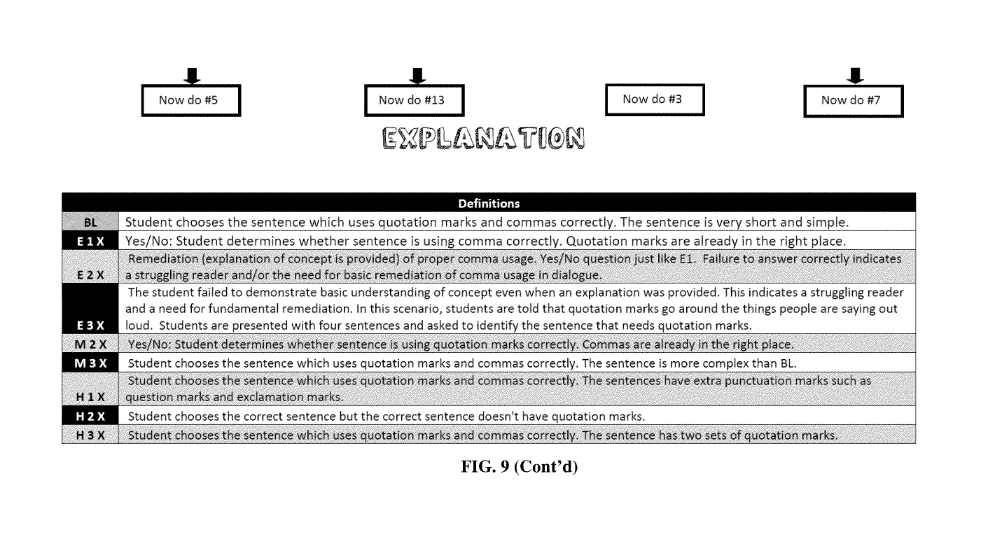

FIGS. 8 and 9 are examples of complete assessments using the techniques described herein. The tables below relate to how a student would progress through the assessment.

In Table 1 below, the level “BL” is a baseline level. H, E, and M are hard, easy, and medium complexity questions. As shown below in Table 1 (an assessment of the Splash Sheet in FIG. 8), if the student answers question 1 correctly (answer C), the student is prompted to take question 11, which is a hard question. If the student answers the question incorrectly, using answer A, the student is prompted to next answer question 13, which is an easy question, and which is related to the type of wrong answer that led the student to answer question 1 with answer A. If the student answers the question incorrectly, using answer B, the student is prompted to next answer question 11, which is an easy question, and which is related to the type of wrong answer that led the student to answer question 1 with answer B. If the student answers the question incorrectly, using answer D, the student is prompted to next answer question 12, which is an easy question, and which is related to the type of wrong answer that led the student to answer question 1 with answer D.

Looking at question 13, if the student answers the question correctly, using answer C, the student is prompted to next answer question 31, which is a question of medium complexity, so that the student does not proceed directly from an easy question to a hard question. As with question 1, if the student answers the question incorrectly, using answer A, the student is prompted to next answer question 32, which is an easy question, and which is related to the type of wrong answer that led the student to answer question 1 with answer A. If the student answers the question incorrectly, using answer B, the student is prompted to next answer question 31, which is an easy question, and which is related to the type of wrong answer that led the student to answer question 1 with answer B. If the student answers the question incorrectly, using answer D, the student is prompted to next answer question 33, which is an easy question, and which is related to the type of wrong answer that led the student to answer question 1 with answer D. This process proceeds until the student has reached the end of the assessment. As shown on the Splash Sheets™ in FIGS. 8 and 9, underneath each question, the student is instructed to either proceed to another question (i.e, with the phrase “Now do #14”), or advised that they are finished with the assessment (i.e, with the phrase “You're Done!”).

TABLE 1

| Ques- | | Destinations | | | |
|---|---|---|---|---|---|
| tion | | A | B | C | D |
| # | Level | 0.827454 | 0.263634 | 0.41132 | 0.635614 |
| | BL | E13 | E11 | H11 | E12 |
| | H21 | H31 | M33 | M32 | M31 |
| | E22 | E33 | E32 | E31 | M31 |
| | M33 | | | | |
| | M21 | H31 | E33 | E32 | E31 |
| | H31 | | | | |
| | E21 | M31 | E33 | E32 | E31 |
| | E12 | E23 | E22 | E21 | M21 |
| | M32 | | | | |
| | E13 | E22 | E21 | M21 | E23 |
| | E33 | | | | |
| | M31 | | | | |
| | E23 | E32 | E31 | M31 | E33 |
| | E32 | | | | |
| | M22 | E33 | E32 | E31 | H31 |
| | E31 | | | | |
| | M23 | E32 | E31 | H31 | E33 |
| | H11 | M23 | M22 | M21 | H21 |
| | E11 | M21 | E23 | E22 | E21 |
| Ques- | | Destinations | | | |
| tion | | A | B | C | D |
| # | Level | 0.94443 | 0.50362 | 0.651934 | 0.433507 |
| | BL | E11 | H11 | E13 | E12 |
| | H21 | M31 | H31 | M33 | M32 |
| | M23 | E33 | E32 | E31 | H31 |
| | M33 | | | | |
| | E12 | M21 | E23 | E22 | E21 |
| | M31 | | | | |
| | M22 | H31 | E33 | E32 | E31 |
| | H11 | H21 | M23 | M22 | M21 |
| | E31 | | | | |
| | E11 | E21 | M21 | E23 | E22 |
| | E23 | E33 | E32 | E31 | M31 |
| | M32 | | | | |
| | E21 | E31 | M31 | E33 | E32 |
| | E33 | | | | |
| | E32 | | | | |
| | E22 | M31 | E33 | E32 | E31 |
| | M21 | E31 | H31 | E33 | E32 |
| | H31 | | | | |
| | E13 | E23 | E22 | E21 | M21 |
| Ques- | | Destinations | | | |
| tion | | A | B | C | D |
| # | Level | 0.842448 | 0.481315 | 0.360522 | 0.744368 |
| | BL | E11 | E12 | H11 | E13 |
| | E32 | | | | |
| | E13 | E23 | M21 | E22 | E21 |
| | H31 | | | | |
| | E23 | E33 | M31 | E32 | E31 |
| | E22 | M31 | E31 | E33 | E32 |
| | M32 | | | | |
| | M33 | | | | |
| | M21 | E31 | E32 | H31 | E33 |
| | E12 | M21 | E21 | E23 | E22 |
| | E11 | E21 | E22 | M21 | E23 |
| | M22 | H31 | E31 | E33 | E32 |
| | M31 | | | | |
| | H21 | M31 | M32 | H31 | M33 |
| | E33 | | | | |
| | E21 | E31 | E32 | M31 | E33 |
| | M23 | E33 | H31 | E32 | E31 |
| | H11 | H21 | M21 | M23 | M22 |
| | E31 | | | | |
| Ques- | | Destinations | | | |
| tion | | A | B | C | D |
| # | Level | 0.413125 | 0.672005 | 0.326361 | 0.161487 |
| | BL | H11 | E11 | E12 | E13 |
| | M32 | | | | |
| | E32 | | | | |
| | M21 | H31 | E31 | E32 | E33 |
| | E33 | | | | |
| | M23 | E32 | E33 | H31 | E31 |
| | M22 | E33 | H31 | E31 | E32 |
| | E11 | M21 | E21 | E22 | E23 |
| | E12 | E23 | M21 | E21 | E22 |
| | H11 | M23 | H21 | M21 | M22 |
| | H31 | | | | |
| | M31 | | | | |
| | H21 | H31 | M31 | M32 | M33 |
| | E13 | E22 | E23 | M21 | E21 |
| | E31 | | | | |
| | M33 | | | | |
| | E21 | M31 | E31 | E32 | E33 |
| | E23 | E32 | E33 | M31 | E31 |
| | E22 | E33 | M31 | E31 | E32 |
| Ques- | | Destinations | | | |
| tion | | A | B | C | D |
| # | Level | 0.374461 | 0.919224 | 0.227334 | 0.150892 |
| | BL | H11 | E12 | E11 | E13 |
| | E11 | M21 | E22 | E21 | E23 |
| | M31 | | | | |
| | H31 | | | | |
| | E21 | M31 | E32 | E31 | E33 |
| | E32 | | | | |
| | M22 | E33 | E31 | H31 | E32 |
| | E23 | E32 | M31 | E33 | E31 |
| | M33 | | | | |
| | H11 | M23 | M21 | H21 | M22 |
| | E22 | E33 | E31 | M31 | E32 |
| | E31 | | | | |
| | E33 | | | | |
| | E13 | E22 | M21 | E23 | E21 |
| | M32 | | | | |
| | E12 | E23 | E21 | M21 | E22 |
| | M21 | H31 | E32 | E31 | E33 |
| | H21 | H31 | M32 | M31 | M33 |
| | M23 | E32 | H31 | E33 | E31 |
| Ques- | | Destinations | | | |
| tion | | A | B | C | D |
| # | Level | 0.160094 | 0.282824 | 0.972603 | 0.900849 |
| | BL | E11 | E13 | E12 | H11 |
| | E31 | | | | |
| | M22 | H31 | E32 | E31 | E33 |
| | M23 | E33 | E31 | H31 | E32 |
| | H31 | | | | |
| | H21 | M31 | M33 | M32 | H31 |
| | M21 | E31 | E33 | E32 | H31 |
| | M31 | | | | |
| | E33 | | | | |
| | E21 | E31 | E33 | E32 | M31 |
| | M32 | | | | |
| | E11 | E21 | E23 | E22 | M21 |
| | E13 | E23 | E21 | M21 | E22 |
| | E32 | | | | |
| | E12 | M21 | E22 | E21 | E23 |
| | M33 | | | | |
| | H11 | H21 | M22 | M21 | M23 |
| | E22 | M31 | E32 | E31 | E33 |
| | E23 | E33 | E31 | M31 | E32 |

| Ques- | | | | |
|---|---|---|---|---|
| tion | | B | C | D |
| # | Level | 0.190187 | 0.830208 | 0.990078 |
| | BL | E13 | E12 | H11 |
| | M21 | E33 | E32 | H31 |
| | M23 | E31 | H31 | E32 |
| | E32 | | | |
| | E21 | E33 | E32 | M31 |
| | E12 | E22 | E21 | E23 |
| | E13 | E21 | M21 | E22 |
| | H21 | M33 | M32 | H31 |
| | E11 | E23 | E22 | M21 |
| | H31 | | | |
| | E31 | | | |
| | E22 | E32 | E31 | E33 |
| | M22 | E32 | E31 | E33 |
| | M31 | | | |
| | H11 | M22 | M21 | M23 |
| | E23 | E31 | M31 | E32 |
| | M33 | | | |
| | E33 | | | |
| | M32 | | | |

| Ques- | | Destinations | | | |
|---|---|---|---|---|---|
| tion | | A | B | C | D |
| # | Level | 0.955719 | 0.585038 | 0.785368 | 0.617578 |
| | BL | E13 | E11 | H11 | E12 |
| | H21 | M33 | M31 | H31 | M32 |
| | E31 | | | | |
| | M32 | | | | |
| | M23 | E31 | E33 | E32 | H31 |
| | M33 | | | | |
| | E22 | E32 | M31 | E33 | E31 |
| | E21 | E33 | E31 | M31 | E32 |
| | M31 | | | | |
| | E23 | E31 | E33 | E32 | M31 |
| | E33 | | | | |
| | E11 | E23 | E21 | M21 | E22 |
| | E13 | E21 | E23 | E22 | M21 |
| | M22 | E32 | H31 | E33 | E31 |
| | E12 | E22 | M21 | E23 | E21 |
| | H31 | | | | |
| | H11 | M22 | H21 | M23 | M21 |
| | E32 | | | | |
| | M21 | E33 | E31 | H31 | E32 |
| Ques- | | Destinations | | | |
| tion | | A | B | C | D |
| # | Level | 0.6137 | 0.389827 | 0.515259 | 0.546656 |
| | BL | E12 | E13 | E11 | H11 |
| | H21 | M32 | M33 | M31 | H31 |
| | H31 | | | | |
| | E21 | E32 | E33 | E31 | M31 |
| | H11 | M21 | M22 | H21 | M23 |
| | M32 | | | | |
| | M31 | | | | |
| | E22 | E31 | E32 | M31 | E33 |
| | E33 | | | | |
| | E12 | E21 | E22 | M21 | E23 |
| | E31 | | | | |
| | M23 | H31 | E31 | E33 | E32 |
| | M22 | E31 | E32 | H31 | E33 |
| | E23 | M31 | E31 | E33 | E32 |
| | M21 | E32 | E33 | E31 | H31 |
| | E13 | M21 | E21 | E23 | E22 |
| | M33 | | | | |
| | E11 | E22 | E23 | E21 | M21 |
| | E32 | | | | |

| Ques- | | Destinations | | |
|---|---|---|---|---|
| tion | | A | B | D |
| # | Level | 0.116652 | 0.974179 | 0.132851 |
| | BL | H11 | E12 | E11 |
| | M32 | | | |
| | M33 | | | |
| | E33 | | | |
| | M31 | | | |
| | H21 | H31 | M32 | M31 |
| | E31 | | | |
| | M23 | E32 | H31 | E33 |
| | M22 | E33 | E31 | H31 |
| | E11 | M21 | E22 | E21 |
| | E21 | M31 | E32 | E31 |
| | M21 | H31 | E32 | E31 |
| | H31 | | | |
| | E12 | E23 | E21 | M21 |
| | E13 | E22 | M21 | E23 |
| | E22 | E33 | E31 | M31 |
| | E23 | E32 | M31 | E33 |
| | E32 | | | |
| | H11 | M23 | M21 | H21 |

Destinations

| A | B | C | D |
|---|---|---|---|
| 0.169606 | 0.384444 | 0.165645 | 0.099573 |
| E12 | E11 | H11 | E13 |
| M32 | M31 | H31 | M33 |
| M21 | H21 | M23 | M22 |
| E32 | E31 | M31 | E33 |
| E32 | E31 | H31 | E33 |
| M21 | E23 | E22 | E21 |
| H31 | E33 | E32 | E31 |
| E31 | H31 | E33 | E32 |
| E31 | M31 | E33 | E32 |
| M31 | E33 | E32 | E31 |
| E22 | E21 | M21 | E23 |
| E21 | M21 | E23 | E22 |

| Ques- | | Destinations | | | |
|---|---|---|---|---|---|
| tion | | A | B | C | D |
| # | Level | 0.422464 | 0.38344 | 0.021003 | 0.255391 |
| | BL | E13 | E12 | E11 | H11 |
| | H11 | M22 | M21 | H21 | M23 |
| | M33 | | | | |
| | M22 | E32 | E31 | H31 | E33 |
| | E13 | E21 | M21 | E23 | E22 |
| | M32 | | | | |
| | E22 | E32 | E31 | M31 | E33 |
| | M21 | E33 | E32 | E31 | H31 |
| | E21 | E33 | E32 | E31 | M31 |
| | E32 | | | | |
| | H31 | | | | |
| | M31 | | | | |
| | E11 | E23 | E22 | E21 | M21 |
| | E12 | E22 | E21 | M21 | E23 |
| | E33 | | | | |
| | E23 | E31 | M31 | E33 | E32 |
| | E31 | | | | |
| | H21 | M33 | M32 | M31 | H31 |
| | M23 | E31 | H31 | E33 | E32 |
| Ques- | | Destinations | | | |
| tion | | A | B | C | D |
| # | Level | 0.535324 | 0.935353 | 0.708253 | 0.677028 |
| | BL | E11 | H11 | E13 | E12 |
| | E13 | E23 | E22 | E21 | M21 |
| | M23 | E33 | E32 | E31 | H31 |
| | E21 | E31 | M31 | E33 | E32 |
| | E23 | E33 | E32 | E31 | M31 |
| | H21 | M31 | H31 | M33 | M32 |
| | M33 | | | | |
| | M21 | E31 | H31 | E33 | E32 |
| | E33 | | | | |
| | M32 | | | | |
| | H31 | | | | |
| | E12 | M21 | E23 | E22 | E21 |
| | M31 | | | | |
| | E11 | E21 | M21 | E23 | E22 |
| | M22 | H31 | E33 | E32 | E31 |
| | E22 | M31 | E33 | E32 | E31 |
| | E31 | | | | |
| | H11 | H21 | M23 | M22 | M21 |
| | E32 | | | | |
| Ques- | | Destinations | | | |
| tion | | A | B | C | D |
| # | Level | 0.114251 | 0.586702 | 0.504527 | 0.34147 |
| | BL | H11 | E11 | E13 | E12 |
| | E33 | | | | |
| | E13 | E22 | E23 | E21 | M21 |
| | M31 | | | | |
| | E23 | E32 | E33 | E31 | M31 |
| | H31 | | | | |
| | M22 | E33 | H31 | E32 | E31 |
| | E32 | | | | |
| | H21 | H31 | M31 | M33 | M32 |
| | E11 | M21 | E21 | E23 | E22 |
| | M23 | E32 | E33 | E31 | H31 |
| | M33 | | | | |
| | M32 | | | | |
| | E21 | M31 | E31 | E33 | E32 |
| | H11 | M23 | H21 | M22 | M21 |
| | E31 | | | | |
| | E22 | E33 | M31 | E32 | E31 |
| | E12 | E23 | M21 | E22 | E21 |
| | M21 | H31 | E31 | E33 | E32 |
| Ques- | | Destinations | | | |
| tion | | A | B | C | D |
| # | Level | 0.009222 | 0.237612 | 0.716921 | 0.012695 |
| | BL | E13 | H11 | E12 | E11 |
| | E33 | | | | |
| | M22 | E32 | E33 | E31 | H31 |
| | H31 | | | | |
| | E32 | | | | |
| | H21 | M33 | H31 | M32 | M31 |
| | E12 | E22 | E23 | E21 | M21 |
| | M33 | | | | |
| | H11 | M22 | M23 | M21 | H21 |
| | E13 | E21 | E22 | M21 | E23 |
| | M23 | E31 | E32 | H31 | E33 |
| | M21 | E33 | H31 | E32 | E31 |
| | E21 | E33 | M31 | E32 | E31 |
| | E22 | E32 | E33 | E31 | M31 |
| | M31 | | | | |
| | M32 | | | | |
| | E31 | | | | |
| | E23 | E31 | E32 | M31 | E33 |
| | E11 | E23 | M21 | E22 | E21 |
| Ques- | | Destinations | | | |
| tion | | A | B | C | D |
| # | Level | 0.893095 | 0.029721 | 0.599857 | 0.76945 |
| | BL | E12 | E11 | E13 | H11 |
| | E13 | M21 | E23 | E21 | E22 |
| | M23 | H31 | E33 | E31 | E32 |
| | H11 | M21 | H21 | M22 | M23 |
| | E32 | | | | |
| | H31 | | | | |
| | E11 | E22 | E21 | E23 | M21 |
| | E21 | E32 | E31 | E33 | M31 |
| | E33 | | | | |
| | M31 | | | | |
| | E31 | | | | |
| | M21 | E32 | E31 | E33 | H31 |
| | M22 | E31 | H31 | E32 | E33 |
| | E12 | E21 | M21 | E22 | E23 |
| | E22 | E31 | M31 | E32 | E33 |
| | E23 | M31 | E33 | E31 | E32 |
| | M32 | | | | |
| | H21 | M32 | M31 | M33 | H31 |
| | M33 | | | | |
| Frame- | | | | | |
| work | | | | | |
| 17 | | | | | |
| Ques- | | Destinations | | | |
| tion | | A | B | C | D |
| # | Level | 0.591014 | 0.876722 | 0.271873 | 0.588866 |
| | BL | E13 | E12 | E11 | H11 |
| | E13 | E21 | M21 | E23 | E22 |
| | M31 | | | | |
| | M33 | | | | |
| | E31 | | | | |
| | H11 | M22 | M21 | H21 | M23 |
| | M23 | E31 | H31 | E33 | E32 |
| | E11 | E23 | E22 | E21 | M21 |
| | E12 | E22 | E21 | M21 | E23 |
| | M32 | | | | |
| | E22 | E32 | E31 | M31 | E33 |
| | H21 | M33 | M32 | M31 | H31 |
| | E21 | E33 | E32 | E31 | M31 |
| | E33 | | | | |
| | H31 | | | | |
| | M21 | E33 | E32 | E31 | H31 |
| | E23 | E31 | M31 | E33 | E32 |
| | M22 | E32 | E31 | H31 | E33 |
| | E32 | | | | |

Destinations

| A | B | C | D |
|---|---|---|---|
| 0.589535 | 0.12197 | 0.310749 | 0.76004 |
| E13 | H11 | E12 | E11 |
| E31 | E32 | H31 | E33 |
| E22 | E23 | E21 | M21 |
| M33 | H31 | M32 | M31 |
| E33 | H31 | E32 | E31 |
| E31 | E32 | M31 | E33 |
| M22 | M23 | M21 | H21 |
| E32 | E33 | E31 | M31 |
| E32 | E33 | E31 | H31 |
| E33 | M31 | E32 | E31 |
| E23 | M21 | E22 | E21 |
| E21 | E22 | M21 | E23 |

| Ques- | | Destinations | | | |
|---|---|---|---|---|---|
| tion | | A | B | C | D |
| # | Level | 0.650081 | 0.501136 | 0.41145 | 0.035118 |
| | BL | E13 | E12 | H11 | E11 |
| | E21 | E33 | E32 | M31 | E31 |
| | M31 | | | | |
| | M21 | E33 | E32 | H31 | E31 |
| | H11 | M22 | M21 | M23 | H21 |
| | E22 | E32 | E31 | E33 | M31 |
| | E23 | E31 | M31 | E32 | E33 |
| | E33 | | | | |
| | M32 | | | | |
| | E32 | | | | |
| | E12 | E22 | E21 | E23 | M21 |
| | E31 | | | | |
| | H21 | M33 | M32 | H31 | M31 |
| | E11 | E23 | E22 | M21 | E21 |
| | E13 | E21 | M21 | E22 | E23 |
| | M22 | E32 | E31 | E33 | H31 |
| | M23 | E31 | H31 | E32 | E33 |
| | H31 | | | | |
| | M33 | | | | |

| Ques- | | | | |
|---|---|---|---|---|
| tion | | B | C | D |
| # | Level | 0.455649 | 0.058861 | 0.042527 |
| | BL | E13 | E11 | E12 |
| | E13 | E21 | E23 | M21 |
| | M32 | | | |
| | E23 | E31 | E33 | M31 |
| | E31 | | | |
| | M23 | E31 | E33 | H31 |
| | E33 | | | |
| | E21 | E33 | E31 | E32 |
| | E11 | E23 | E21 | E22 |
| | H21 | M33 | M31 | M32 |
| | M22 | E32 | H31 | E31 |
| | E12 | E22 | M21 | E21 |
| | E32 | | | |
| | E22 | E32 | M31 | E31 |
| | M21 | E33 | E31 | E32 |
| | M33 | | | |
| | H31 | | | |
| | H11 | M22 | H21 | M21 |
| | M31 | | | |

| Ques- | | Destinations | | | |
|---|---|---|---|---|---|
| tion | | A | B | C | D |
| # | Level | 0.497781 | 0.230731 | 0.27435 | 0.78686 |
| | BL | H11 | E13 | E11 | E12 |
| | M31 | | | | |
| | M22 | E33 | E32 | H31 | E31 |
| | E23 | E32 | E31 | E33 | M31 |
| | M21 | H31 | E33 | E31 | E32 |
| | E13 | E22 | E21 | E23 | M21 |
| | E33 | | | | |
| | M32 | | | | |
| | M33 | | | | |
| | H31 | | | | |
| | H21 | H31 | M33 | M31 | M32 |
| | E31 | | | | |
| | M23 | E32 | E31 | E33 | H31 |
| | E22 | E33 | E32 | M31 | E31 |
| | E12 | E23 | E22 | M21 | E21 |
| | E11 | M21 | E23 | E21 | E22 |
| | E21 | M31 | E33 | E31 | E32 |
| | E32 | | | | |
| | H11 | M23 | M22 | H21 | M21 |
| Ques- | | Destinations | | | |
| tion | | A | B | C | D |
| # | Level | 0.145253 | 0.907272 | 0.300168 | 0.065731 |
| | BL | H11 | E11 | E13 | E12 |
| | H11 | M23 | H21 | M22 | M21 |
| | E21 | M31 | E31 | E33 | E32 |
| | E22 | E33 | M31 | E32 | E31 |
| | M31 | | | | |
| | E12 | E23 | M21 | E22 | E21 |
| | H21 | H31 | M31 | M33 | M32 |
| | E31 | | | | |
| | H31 | | | | |
| | E13 | E22 | E23 | E21 | M21 |
| | E11 | M21 | E21 | E23 | E22 |
| | M22 | E33 | H31 | E32 | E31 |
| | E33 | | | | |
| | M23 | E32 | E33 | E31 | H31 |
| | M33 | | | | |
| | E23 | E32 | E33 | E31 | M31 |
| | M21 | H31 | E31 | E33 | E32 |
| | M32 | | | | |
| | E32 | | | | |

| Ques- | | Destinations | | |
|---|---|---|---|---|
| tion | | A | B | D |
| # | Level | 0.093129 | 0.130195 | 0.788762 |
| | BL | E13 | H11 | E11 |
| | M22 | E32 | E33 | H31 |
| | E13 | E21 | E22 | E23 |
| | E11 | E23 | M21 | E21 |
| | M32 | | | |
| | E23 | E31 | E32 | E33 |
| | M23 | E31 | E32 | E33 |
| | E31 | | | |
| | H11 | M22 | M23 | H21 |
| | M33 | | | |
| | H31 | | | |
| | E21 | E33 | M31 | E31 |
| | M31 | | | |
| | E32 | | | |
| | E12 | E22 | E23 | M21 |
| | H21 | M33 | H31 | M31 |
| | E33 | | | |
| | E22 | E32 | E33 | M31 |
| | M21 | E33 | H31 | E31 |

| Ques- | | Destinations | | | |
|---|---|---|---|---|---|
| tion | | A | B | C | D |
| # | Level | 0.60809 | 0.681987 | 0.444187 | 0.456638 |
| | BL | E11 | H11 | E12 | E13 |
| | E32 | | | | |
| | E33 | | | | |
| | E12 | M21 | E23 | E21 | E22 |
| | M21 | E31 | H31 | E32 | E33 |
| | E11 | E21 | M21 | E22 | E23 |
| | H11 | H21 | M23 | M21 | M22 |
| | E22 | M31 | E33 | E31 | E32 |
| | E23 | E33 | E32 | M31 | E31 |
| | M31 | | | | |
| | E31 | | | | |
| | E21 | E31 | M31 | E32 | E33 |
| | M33 | | | | |
| | H31 | | | | |
| | M23 | E33 | E32 | H31 | E31 |
| | E13 | E23 | E22 | M21 | E21 |
| | H21 | M31 | H31 | M32 | M33 |
| | M32 | | | | |
| | M22 | H31 | E33 | E31 | E32 |
| Ques- | | Destinations | | | |
| tion | | A | B | C | D |
| # | Level | 0.714569 | 0.494349 | 0.681096 | 0.10974 |
| | BL | E13 | E11 | H11 | E12 |
| | M22 | E32 | H31 | E33 | E31 |
| | E21 | E33 | E31 | M31 | E32 |
| | M32 | | | | |
| | M31 | | | | |
| | M21 | E33 | E31 | H31 | E32 |
| | E12 | E22 | M21 | E23 | E21 |
| | E23 | E31 | E33 | E32 | M31 |
| | M23 | E31 | E33 | E32 | H31 |
| | E22 | E32 | M31 | E33 | E31 |
| | M33 | | | | |
| | E32 | | | | |
| | H21 | M33 | M31 | H31 | M32 |
| | H11 | M22 | H21 | M23 | M21 |
| | E31 | | | | |
| | E11 | E23 | E21 | M21 | E22 |
| | E13 | E21 | E23 | E22 | M21 |
| | H31 | | | | |
| | E33 | | | | |
| Ques- | | Destinations | | | |
| tion | | A | B | C | D |
| # | Level | 0.342554 | 0.167824 | 0.842555 | 0.514426 |
| | BL | E13 | E12 | E11 | H11 |
| | E33 | | | | |
| | M33 | | | | |
| | E23 | E31 | M31 | E33 | E32 |
| | E12 | E22 | E21 | M21 | E23 |
| | M21 | E33 | E32 | E31 | H31 |
| | E32 | | | | |
| | M32 | | | | |
| | M22 | E32 | E31 | H31 | E33 |
| | E13 | E21 | M21 | E23 | E22 |
| | H31 | | | | |
| | H11 | M22 | M21 | H21 | M23 |
| | E31 | | | | |
| | E21 | E33 | E32 | E31 | M31 |
| | M23 | E31 | H31 | E33 | E32 |
| | M31 | | | | |
| | E22 | E32 | E31 | M31 | E33 |
| | H21 | M33 | M32 | M31 | H31 |
| | E11 | E23 | E22 | E21 | M21 |
| Ques- | | Destinations | | | |
| tion | | A | B | C | D |
| # | Level | 0.584197 | 0.027589 | 0.686981 | 0.094243 |
| | BL | E12 | E13 | H11 | E11 |
| | E11 | E22 | E23 | M21 | E21 |
| | M22 | E31 | E32 | E33 | H31 |
| | M33 | | | | |
| | M21 | E32 | E33 | H31 | E31 |
| | H21 | M32 | M33 | H31 | M31 |
| | E23 | M31 | E31 | E32 | E33 |
| | M23 | H31 | E31 | E32 | E33 |
| | E33 | | | | |
| | H31 | | | | |
| | E32 | | | | |
| | E31 | | | | |
| | M31 | | | | |
| | E22 | E31 | E32 | E33 | M31 |
| | H11 | M21 | M22 | M23 | H21 |
| | E12 | E21 | E22 | E23 | M21 |
| | M32 | | | | |
| | E21 | E32 | E33 | M31 | E31 |
| | E13 | M21 | E21 | E22 | E23 |
| Ques- | | Destinations | | | |
| tion | | A | B | C | D |
| # | Level | 0.852668 | 0.130951 | 0.182824 | 0.710914 |
| | BL | E11 | H11 | E12 | E13 |
| | E32 | | | | |
| | E33 | | | | |
| | E22 | M31 | E33 | E31 | E32 |
| | E21 | E31 | M31 | E32 | E33 |
| | H21 | M31 | H31 | M32 | M33 |
| | M23 | E33 | E32 | H31 | E31 |
| | E31 | | | | |
| | M22 | H31 | E33 | E31 | E32 |
| | M21 | E31 | H31 | E32 | E33 |
| | E23 | E33 | E32 | M31 | E31 |
| | M32 | | | | |
| | E13 | E23 | E22 | M21 | E21 |
| | E12 | M21 | E23 | E21 | E22 |
| | H31 | | | | |
| | M33 | | | | |
| | E11 | E21 | M21 | E22 | E23 |
| | H11 | H21 | M23 | M21 | M22 |
| | M31 | | | | |
| Ques- | | Destinations | | | |
| tion | | A | B | C | D |
| # | Level | 0.349947 | 0.790988 | 0.599255 | 0.772009 |
| | BL | H11 | E13 | E11 | E12 |
| | E22 | E33 | E32 | M31 | E31 |
| | M33 | | | | |
| | E12 | E23 | E22 | M21 | E21 |
| | M22 | E33 | E32 | H31 | E31 |
| | E21 | M31 | E33 | E31 | E32 |
| | E31 | | | | |
| | E13 | E22 | E21 | E23 | M21 |
| | E11 | M21 | E23 | E21 | E22 |
| | M21 | H31 | E33 | E31 | E32 |
| | M32 | | | | |
| | E33 | | | | |
| | M23 | E32 | E31 | E33 | H31 |
| | H11 | M23 | M22 | H21 | M21 |
| | M31 | | | | |
| | E23 | E32 | E31 | E33 | M31 |
| | E32 | | | | |
| | H21 | H31 | M33 | M31 | M32 |
| | H31 | | | | |
| Frame- | | | | | |
| work | | | | | |
| 30 | | | | | |
| Ques- | | Destinations | | | |
| tion | | A | B | C | D |
| # | Level | 0.298386 | 0.97945 | 0.983415 | 0.15508 |
| | BL | E11 | H11 | E12 | E13 |
| | E11 | E21 | M21 | E22 | E23 |
| | E13 | E23 | E22 | M21 | E21 |
| | H11 | H21 | M23 | M21 | M22 |
| | M21 | E31 | H31 | E32 | E33 |
| | E22 | M31 | E33 | E31 | E32 |
| | M33 | | | | |
| | H31 | | | | |
| | E12 | M21 | E23 | E21 | E22 |
| | M23 | E33 | E32 | H31 | E31 |
| | M32 | | | | |
| | H21 | M31 | H31 | M32 | M33 |
| | M31 | | | | |
| | E31 | | | | |
| | E21 | E31 | M31 | E32 | E33 |
| | E23 | E33 | E32 | M31 | E31 |
| | E33 | | | | |
| | E32 | | | | |
| | M22 | H31 | E33 | E31 | E32 |
| Ques- | | Destinations | | | |
| tion | | A | B | C | D |
| # | Level | 0.041311 | 0.350743 | 0.275962 | 0.641996 |
| | BL | E13 | E11 | H11 | E12 |
| | M23 | E31 | E33 | E32 | H31 |
| | H31 | | | | |
| | E12 | E22 | M21 | E23 | E21 |
| | M31 | | | | |
| | E11 | E23 | E21 | M21 | E22 |
| | E33 | | | | |
| | H11 | M22 | H21 | M23 | M21 |
| | E31 | | | | |
| | E23 | E31 | E33 | E32 | M31 |
| | M32 | | | | |
| | M22 | E32 | H31 | E33 | E31 |
| | E21 | E33 | E31 | M31 | E32 |
| | M33 | | | | |
| | H21 | M33 | M31 | H31 | M32 |
| | E22 | E32 | M31 | E33 | E31 |
| | E32 | | | | |
| | M21 | E33 | E31 | H31 | E32 |
| | E13 | E21 | E23 | E22 | M21 |
| Ques- | | Destinations | | | |
| tion | | A | B | C | D |
| # | Level | 0.617393 | 0.146583 | 0.012257 | 0.566496 |
| | BL | E13 | H11 | E12 | E11 |
| | M33 | | | | |
| | E13 | E21 | E22 | M21 | E23 |
| | E22 | E32 | E33 | E31 | M31 |
| | E23 | E31 | E32 | M31 | E33 |
| | M23 | E31 | E32 | H31 | E33 |
| | H31 | | | | |
| | E32 | | | | |
| | M31 | | | | |
| | M21 | E33 | H31 | E32 | E31 |
| | M32 | | | | |
| | E21 | E33 | M31 | E32 | E31 |
| | H11 | M22 | M23 | M21 | H21 |
| | H21 | M33 | H31 | M32 | M31 |
| | E31 | | | | |
| | E33 | | | | |
| | E11 | E23 | M21 | E22 | E21 |
| | M22 | E32 | E33 | E31 | H31 |
| | E12 | E22 | E23 | E21 | M21 |

In one aspect of this embodiment, specific lesson plans can be provided around the subject matter for the various questions, so that teachers can focus on those aspects where a significant number of students have shown difficulty in understanding the material. In another aspect of this embodiment, the assessment can include a section to which the student is directed after getting a question or series of questions wrong, which section provides specific instruction to help teach and/or reinforce the material, ideally before the student proceeds to the next question.

Using the tables and assessments (referred to in FIGS. 8 and 9 as “Splash Sheets™”), students can learn subject matter in an iterative fashion, proceeding from easy, to harder, to still harder questions in a manner that assists them in learning the subject matter. Ideally, if the questions are geared toward national, regional, or local standards, the assessments can better prepare students for standardized tests, including the SAT, ACT, ACH, and PSAT/NMSQT (Preliminary SAT/National Merit Scholarship Qualifying Test), Intelligence Quotient (“IQ”) tests such as the Stanford-Binet Intelligence Scales (SB5), Wechsler Intelligence Scale for Children (WISC), Wechsler Preschool and Primary Scale of Intelligence (WPPSI), Otis-Lennon School Ability Test, admissions tests such as the ISEE (Independent School Entrance Examination), the SSAT (Secondary School Admission Test), the HSPT (High School Placement Test), the California Achievement Test, PLAN, EXPLORE, the ELPT (English Language Proficiency Test), STAR Early Literacy, STAR Math, and STAR Reading, the Stanford Achievement Test, TerraNova, and WorkKeys, and NAEP (National Assessment of Educational Progress) and other standardized state achievement tests required in American public schools for the schools to receive federal funding.

Representative state tests for which the teaching assessments described herein can be used to prepare include, but are not limited to, AHSGE (Alabama High School Graduation Exam), ARMT (Alabama Reading and Mathematics Test), HSGQE (Alaska High School Graduation Qualifying Examination), Alaska Standards-based assessment, AIMS (Arizona's Instrument to Measure Standards), Arkansas Education Augmented Benchmark Examinations, California Department of Education STAR (Standardized Testing and Reporting), CAHSEE (California High School Exit Exam), CSAP (Colorado Student Assessment Program), CAPT (Connecticut Academic Performance Test), CMT (Connecticut Mastery Test), DCAS (Delaware Comprehensive Assessment System), DC-CAS (District of Columbia Comprehensive Assessment System), FCAT (Florida Comprehensive Assessment Test), CRCT (Georgia Criterion-Referenced Competency Tests), GHSGT (Georgia High School Graduation Test), GAA (Georgia Alternate Assessment), Georgia Writings Assessments, EOCT, HSA/HSAA (Hawaii State Assessment/Hawaii State Alternative Assessment), I-SAT (Idaho Standards Achievement Test), ISAT (Illinois Standards Achievement Test), PSAE (Prairie State Achievement Examination), I-STEP+(Indiana Statewide Testing for Educational Progress-Plus), ITBS (Iowa Test of Basic Skills), ITED (Iowa Tests of Educational Development), Kansas Mathematics Assessment, Kansas Reading Assessment, Kansas Writing Assessment, Kansas Science Assessment, Kansas History, Government, Economics and Geography Assessment, Kentucky CATS (Commonwealth Accountability Testing System), LEAP (Louisiana Educational Assessment Program), iLEAP (Integrated Graduate Exit Examination), GEE, MEA (Maine Educational Assessment), MHSA (Maine High School Assessment), MSA (Maryland School Assessment), MHSA (Maryland High School Assessment), MCAS (Massachusetts Comprehensive Assessment System), MEAP (Michigan Educational Assessment Program), MME (Michigan Merit Exam), MCA-II (Minnesota Department of Education Minnesota Comprehensive Assessments—Series II), MFLE (Mississippi Functional Literacy Exam), MCT (Mississippi Curriculum Test), MAP (Missouri Assessment Program), MontCAS (Montana Comprehensive Assessment System), NPEP (Nevada Proficiency Examination Program), NECAP (New England Common Assessment Program), NJASK (New Jersey Assessment of Skills and Knowledge), GEPA (Grade Eight Proficiency Assessment, High School Proficiency Assessment), NMSBA (New Mexico Standards-based assessment), NMAPA (New Mexico Alternate Performance Assessment), New York State Department of Education Regents Examinations, North Carolina End of Grade Tests (Grades 3-8, EOGs) and End of Course Tests (Grades 9-12, EOCs), North Dakota State Assessment, OAA (Ohio Achievement Assessment), OGT (Ohio Graduation Test), OCCT (Oklahoma Core Curriculum Tests), OAKS (Oregon Assessment of Knowledge and Skills), PSSA (Pennsylvania System of School Assessment), PASA (Pennsylvania Alternate School Assessment), South Carolina Department of Education —PASS (Palmetto Assessment of State Standards, Grades 3-8) and HSAP (High School Assessment Program, Grades 9-12) DSTEP (South Dakota State Test of Educational Progress DSTEP), TCAP (Tennessee Comprehensive Assessment Program), STAAR (State of Texas Assessments of Academic Readiness), ITBS (Iowa Test of Basic Skills), ITED (Iowa Tests of Educational Development), SOL (Virginia—Standards of Learning), SASL (Washington Assessment of Student Learning), WESTEST (West Virginia Educational Standards Test), WKCE (Wisconsin Knowledge and Concepts Examination), and PAWS (Proficiency Assessments for Wyoming Students).

Thus, using the techniques described herein, students can better prepare for any of a variety of standardized tests in an iterative manner, and teachers can better understand those areas in which their students are strongest and weakest. This can allow for individualized learning, even in a public school environment, as teachers can separately focus on those students with little or no mastery, an intermediate mastery, or a mastery of any given subject matter covered in the assessments described herein.

While the invention has been has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Correspondingly, the invention as hereinafter claimed is intended to be broadly construed and interpreted, as including all such variations, modifications and alternative embodiments, within its spirit and scope.

1. An assessment device correlated to educational standards of at least one region, the assessment device comprising a series of questions of different levels of complexity, ranging from easy, to medium, to hard, organized in a manner that initially tests students on a question of medium complexity, in which each answer leads the test taker to a different question based on how he/she answered the earlier question, until a predetermined termination criteria is met,
optionally including one or a plurality of identifiers dispersed within the assessment device, wherein different identifiers from the plurality of identifiers correspond to specific educational standards of the at least one region,
wherein the assessment device comprises questions based on a particular educational standard of the at least one region.

2. The assessment device of claim 1, wherein the device comprises questions which encompass a plurality of academic disciplines, including at least two of the following academic disciplines (i) to (iv): (i) science; (ii) mathematics; (iii) social studies; and (iv) any of English, language arts, reading, and writing.

3. The assessment device of claim 1, in print form.

4. The assessment device of claim 1, in digital form.

5. The assessment device of claim 1, wherein the assessment device comprises software adapted to operate on a microprocessor-based computing device having an associated input element and an associated display element arranged to display the series of questions.

6. The assessment device of claim 5, wherein the assessment device is accessible via a computer network.

7. A microprocessor-based computer hardware and software system incorporating the assessment device of claim 5.

8. The system of claim 7, wherein each identifier of the plurality of identifiers comprises a selectable hyperlink, wherein the hyperlink is adapted to permit viewing of at least a portion of the viewable index and/or to a textual identification of an educational standard corresponding to the identifier.

9. The assessment device of claim 1, wherein the questions based on the educational standards of at least one region includes educational standards of a plurality of regions.

10. The assessment device of claim 1, in the form of a worksheet, test, a quiz, or a homework assignment.

11. The assessment device of claim 10, wherein the test is a pretest, summative assessment, or formative assessment.

12. An educational instruction method including providing one or more students with access to the assessment device of claim 1, and having them answer the questions provided in the assessment device in the order in which the device instructs the students to take the questions, until a predetermined termination criteria is met.

13. The educational instruction method of claim 12, wherein the assessment device comprises a non-electronic print medium.

14. The educational instructional method of claim 12, wherein the assessment device comprises an electronic medium.

15. The educational instructional method of claim 14, wherein each identifier of the plurality of identifiers comprises a selectable hyperlink, wherein the hyperlink is adapted to permit viewing of the viewable index and/or to a textual identification of an educational standard corresponding to the identifier.

16. The method of claim 12, further comprising collating data regarding the performance of the one or more students at answering the questions on the assessment device.

17. The method of claim 16, further comprising determining from the collated data which students understand the topic very well, which students have a modest grasp of the material, and which students have a poor grasp of the material.

18. The method of claim 17, further comprising breaking the students into groups depending on their mastery of the questions, and providing separate instruction to the students depending on which group they are in.

19. The method of claim 18, wherein a series of lesson plans are prepared, one for each of the groups into which the students are place, in advance of the students being separated into different groups.

20. An educational kit, comprising the assessment device of claim 1, and a series of lesson plans, each geared to one of the following groups of students:
a) students who understand the evaluated material very well,
b) students who have a modest grasp of the evaluated material, and
c) students which have a poor grasp of the evaluated material.

21. The educational kit of claim 20, wherein the assessment device and/or lesson plans are provided in electronic form.

22. The educational kit of claim 21, wherein the assessment device is designed such that students can access the assessment device, and answer the questions present in the assessment device, through a local area network or through the internet, either through a conventional laptop or desktop computer, or through a personal digital assistant.

23. The educational kit of claim 20, wherein the assessment device and/or lesson plans are provided in the form of a worksheet, test, a quiz, or a homework assignment.

24. The educational kit of claim 23, wherein the test is a pretest, summative assessment, or formative assessment.
